(19) United States
(12) Patent Application Publication
(10) Pub. No.: US 2026/0164471 A1
(43) Pub. Date: Jun. 11, 2026

(54) EVENT INFORMATION FOR A NEAR FIELD EVENT

(71) Applicant: Lenovo (United States) Inc., Morrisville, NC (US)

(72) Inventors: Vijay Nangia, Woodridge, IL (US); Ahmed Hindy, Aurora, IL (US)

(73) Assignee: Lenovo (United States) Inc., Morrisville, NC (US)

(21) Appl. No.: 18/976,014

(22) Filed: Dec. 10, 2024

(51) Int. Cl. H04W 74/0833; H04W 4/80; H04W 72/044

(52) U.S. Cl. CPC H04W 74/0833; H04W 4/80; H04W 72/046

(57) ABSTRACT

Various aspects of the present disclosure relate to event information for a near field event. An apparatus, such as a user equipment (UE), receives a set of beams and selects a beam from the set of beams based at least in part on one or more beam quality values. The apparatus transmits a random access channel (RACH) preamble indicating an identifier of the selected beam and receives a system information message including event information for a near field event. The apparatus receives a random-access response (RAR) message including an acknowledgement of the RACH preamble, and transmits, based at least in part on the RAR message and the one or more beam quality values of the set of beams, an event indication of whether the near field event is detected.

### TECHNICAL FIELD

The present disclosure relates to wireless communications, and more specifically to near field communication in wireless communication.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a set of beams; select a beam from the set of beams based at least in part on one or more beam quality values; transmit a random access channel (RACH) preamble indicating an identifier of the selected beam; receive a system information message including event information for a near field event; receive a random-access response (RAR) message including an acknowledgement of the RACH preamble; and transmit, based at least in part on the RAR message and the one or more beam quality values of the set of beams, an event indication of whether the near field event is detected.

A processor (e.g., a standalone processor chipset, or a component of a UE) for wireless communication is described. The processor may be configured to, capable of, or operable to perform one or more operations as described herein. For example, the processor may be configured to, capable of, or operable to receive a set of beams; select a beam from the set of beams based at least in part on one or more beam quality values; transmit a RACH preamble indicating an identifier of the selected beam; receive a system information message including event information for a near field event; receive a RAR message including an acknowledgement of the RACH preamble; and transmit, based at least in part on the RAR message and the one or more beam quality values of the set of beams, an event indication of whether the near field event is detected.

A method performed or performable by a UE for wireless communication is described. The method may include receiving a set of beams; selecting a beam from the set of beams based at least in part on one or more beam quality values; transmitting a RACH preamble indicating an identifier of the selected beam; receiving a system information message including event information for a near field event; receiving a RAR message including an acknowledgement of the RACH preamble; and transmitting, based at least in part on the RAR message and the one or more beam quality values of the set of beams, an event indication of whether the near field event is detected.

In some implementations of the UE, the processor, and the method described herein, the near field event is configured to trigger a near-field operation mode, and the near-field operation mode corresponds to the UE being in a closer proximity to a NE compared with one or more other UEs that are not triggered with the near-field operation mode.

In some implementations of the UE, the processor, and the method described herein, the UE, the processor, and the method may further be configured to, capable of, operable to, performed to, or performable to measure the one or more beam quality values for each beam of the set of beams, where the selected beam is associated with a best beam quality within the set of beams based at least in part on the one or more beam quality values.

In some implementations of the UE, the processor, and the method described herein, each beam of the set of beams is associated with a synchronization signal block (SSB) resource.

the near field event corresponds to a beam quality value of the selected beam meeting a first threshold value, and where the event information includes the first threshold value.

In some implementations of the UE, the processor, and the method described herein, the near field event corresponds to a beam quality value of the selected beam meeting a first threshold value, and where the event information includes the first threshold value.

In some implementations of the UE, the processor, and the method described herein, the beam quality value includes one or more of a reference signal received power (RSRP) value or a signal-to-interference-and-noise ratio (SINR) value.

In some implementations of the UE, the processor, and the method described herein, the system information message includes a system information block 1 (SIB-1) message.

In some implementations of the UE, the processor, and the method described herein, the near field event corresponds to a difference between a first beam quality value of the selected beam and a second beam quality value associated with a non-selected beam of the set of beams being smaller than a second threshold value.

In some implementations of the UE, the processor, and the method described herein, the non-selected beam corresponds to a beam associated with at least one of: a fourth best beam quality within the set of beams with a median beam quality within the set of beams; or a best beam quality of a subset of beams corresponding to a weakest beam quality within the set of beams.

In some implementations of the UE, the processor, and the method described herein, the first beam quality value and the second beam quality value include one or more of RSRP values or SINR values.

In some implementations of the UE, the processor, and the method described herein, the event indication of whether the near field event is detected is included in a field of a physical uplink shared channel (PUSCH).

In some implementations of the UE, the processor, and the method described herein, a presence of the field in the PUSCH is conditioned at least in part on the event information being included in the system information message.

In some implementations of the UE, the processor, and the method described herein, the UE, the processor, and the method may further be configured to, capable of, operable to, performed to, or performable to receive a contention resolution message subsequent to transmission of the event indication, where the contention resolution message includes at least one of an acknowledgement of the event indication or a cell radio network identifier.

In some implementations of the UE, the processor, and the method described herein, the system information message is received as part of an initial access procedure between the UE and a NE.

An NE (e.g., a base station) for wireless communication is described. The NE may be configured to, capable of, or operable to perform one or more operations as described herein. For example, the NE may be configured to, capable of, or operable to transmit a set of beams; receive a RACH preamble indicating an identifier of a selected beam from the set of beams; transmit a system information message including event information for a near field event; transmit a RAR message including an acknowledgement of the RACH preamble; and receive, based at least in part on the RAR message and one or more beam quality values of the set of beams, an event indication of whether the near field event is detected.

A processor (e.g., a standalone processor chipset, or a component of a NE) for wireless communication is described. The processor may be configured to, capable of, or operable to perform one or more operations as described herein. For example, the processor may be configured to, capable of, or operable to transmit a set of beams; receive a RACH preamble indicating an identifier of a selected beam from the set of beams; transmit a system information message including event information for a near field event; transmit a RAR message including an acknowledgement of the RACH preamble; and receive, based at least in part on the RAR message and one or more beam quality values of the set of beams, an event indication of whether the near field event is detected.

A method performed or performable by an NE (e.g., a base station) for wireless communication is described. The method may include transmitting a set of beams; receiving a RACH preamble indicating an identifier of a selected beam from the set of beams; transmitting a system information message including event information for a near field event; transmitting a RAR message including an acknowledgement of the RACH preamble; and receiving, based at least in part on the RAR message and one or more beam quality values of the set of beams, an event indication of whether the near field event is detected.

In some implementations of the NE, the processor, and the method described herein, each beam of the set of beams includes a SSB resource.

In some implementations of the NE, the processor, and the method described herein, the near field event corresponds to a beam quality value of the selected beam meeting a first threshold value, and where the event information includes the first threshold value.

In some implementations of the NE, the processor, and the method described herein, the beam quality value includes one or more of a RSRP value or a SINR value.

In some implementations of the NE, the processor, and the method described herein, the system information message is transmitted as part of an initial access procedure between the NE and a UE.

### BRIEF DESCRIPTION OF THE DRAWINGS

FIG. 1 illustrates an example of a wireless communications system in accordance with aspects of the present disclosure.

FIG. 2 illustrates a scenario for aperiodic trigger state defining a list of channel state information (CSI) report settings.

FIG. 3 illustrates aperiodic trigger state indicating a resource set and QCL information.

FIG. 4 illustrates RRC configuration for non-zero power (NZP) CSI reference signal (RS) (NZP-CSI-RS).

FIG. 5 illustrates RRC configuration for CSI interference management (CSI-IM) resources.

FIG. 6 illustrates a scenario for partial CSI omission.

FIG. 7 illustrates example information element for configuring an NZP-CSI-RS resource set.

FIG. 8 illustrates an example TRS configuration, as related to multi-resolution precoding based on multiple submatrices in accordance with aspects of the present disclosure.

FIG. 9 illustrates an example information element.

FIG. 10 illustrates an example information element.

FIG. 11 illustrates an example information element.

FIGS. 12 and 13 illustrate an example of demodulation reference signal (DMRS) patterns for mapping Type A with front-load DMRS.

FIG. 14 depicts an example wireless communication system in accordance with aspects of the present disclosure.

FIG. 15 illustrates an example of a UE in accordance with aspects of the present disclosure.

FIG. 16 illustrates an example of a processor in accordance with aspects of the present disclosure.

FIG. 17 illustrates an example of an NE in accordance with aspects of the present disclosure.

FIG. 18 illustrates a flowchart of a method in accordance with aspects of the present disclosure.

FIG. 19 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. As part of utilizing time-frequency resources, beamforming can be implemented to provide signal direction focus for signals between different devices, e.g., between UEs and NEs. In wireless networks, increasing bandwidth values can support higher data rates, which can be enabled by higher carrier frequency values and larger antenna arrays. However, this can cause increases in the Fraunhofer (Rayleigh) distance within a coverage area of a cell, and thus an increase in the possibility of UEs being located within the near field region of a cell. UEs in the near field region can incur a different channel distribution (e.g., than UEs in a far field region) with parameters that are strongly dependent on antenna location within an antenna subarray. Near field UEs may thus involve different beamforming techniques than far field UEs to improve channel gains.

Some wireless communications systems may accommodate beamforming for near field UEs. For instance, wireless communications systems may implement multi-stage beamforming, where a network supports multiple stages of beamforming. In multi-stage beamforming, a first stage includes far field beams (e.g., beams designed for UEs in the far field region), and based on UE reported beams in the first stage, a second stage of beamforming can be configured that is conditioned on the reported beams in the first stage of beamforming. The second stage of beamforming can include beams designed for UEs in the near field region (e.g., near field beams), e.g., a polar-based codebook of beams. Two-stage beamforming, however, can incur large latency due to support of a two-stage beamforming model.

In some instances, a wireless communications system may support communication devices using a larger beam codebook of beams. For instance, a network supports a one-stage beamforming scheme with a superset including an aggregation of far field beams and near field beams. The far field beams can be based on conventional design (e.g., discrete Fourier transform (DFT) beams), and near field beams can be based on beam codebook design for near field UEs, e.g., polar beam codebook. Using a larger beam codebook, however, can cause exhaustion of resources available for beam training, in addition to higher complexity for UEs in the near field and far field regions.

In some cases, a wireless communications system may support piecewise beamforming per antenna array. For instance, a network can support a one-stage beamforming scheme with far field beams transmitted independently from each antenna subarray. Piecewise beamforming, however, can introduce additional complexity for UEs in a far field region that do not need to track beams independently from each antenna subarray, leading to additional CPU resources and more active resources allocated to beamforming for UEs in the network.

Aspects of the present disclosure are described in the context of a wireless communications system, and include implementations that provide a framework that enables a network to identify UEs in the near field region, and that supports near field-based schemes for beamforming towards the UEs in the near field region. For example, a piecewise far field beamforming approach is described over multiple subarrays of a large antenna array, where a first UE in the near field region reports a best (e.g., highest quality) beam for each antenna subarray, and a second UE in the far field region reports a best beam for one or more subarrays of multiple antenna subarrays. A UE may measure and utilize a set of metrics to identify whether the UE is in the near field region or in the far field region. In such cases, the metrics can be configurable by the network. Implementations described herein also enable identifying one or more antenna subarrays within multiple antenna subarrays that incur full or partial blockage.

Solutions described herein also provide a framework that utilizes beams received in repetition mode to identify (e.g., concurrently, simultaneously) strongest downlink transmit beams per antenna subarray for a first UE in a near field region, and identify (e.g., concurrently, simultaneously) best (e.g., highest correspondence) downlink receive filters for a second UE in the far field region. An enhanced initial access procedure is also described that enables identification of UEs in the near field region via a configured threshold of beam power over a system information block (SIB) message, where the UE can signal an indicator of whether the threshold condition is met, e.g., as part of a msg3 sequence.

By performing the described techniques, a wireless communications system can identify near field UEs and far field UEs and implement beamforming that is tailored to the near field UEs and far field UEs. The described techniques can reduce resource usage at both the UE and the NE for resources allocated to identifying near field UEs and beamforming, such as power resources, processing resources, time-frequency resources, etc.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

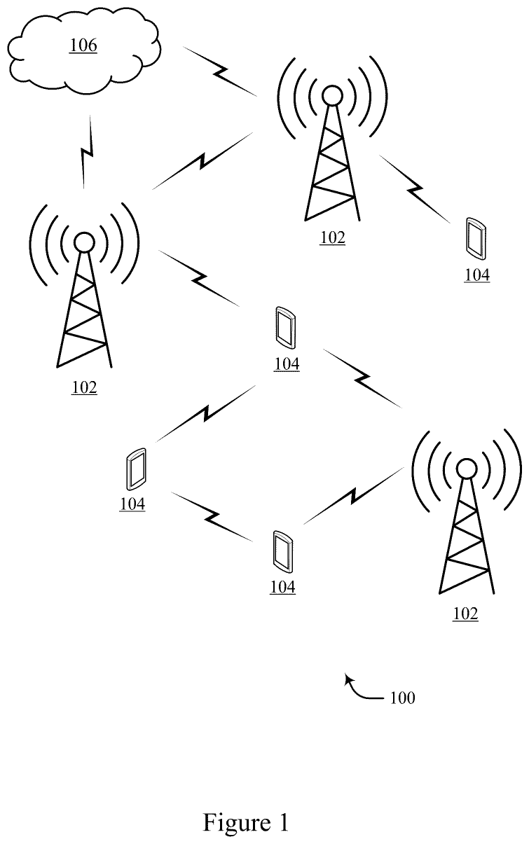

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives, from a NE 102 a set of beams and selects a beam from the set of beams based at least in part on one or more beam quality values. The UE 104 transmits, to the NE 102, a RACH preamble indicating an identifier of the selected beam, and receives a system information message including event information for a near field event. The UE 104 receives, from the NE 104, a RAR message including an acknowledgement of the RACH preamble, and transmits, to the NE 104 and based at least in part on the RAR message and the one or more beam quality values of the set of beams, an event indication of whether the near field event is detected.

Further to implementations, a NE 102 transmits, to a UE 104 a set of beams and receives a RACH preamble indicating an identifier of a selected beam from the set of beams. The NE 102 transmits, to the UE 104, a system information message including event information for a near field event, and transmits a RAR message including an acknowledgement of the RACH preamble. The NE 104 receives, from the UE 104 and based at least in part on the RAR message and one or more beam quality values of the set of beams, an event indication of whether the near field event is detected.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

The following provides a summary of NR codebook types and additional details can be found in 3GPP Technical Specification (TS) 38.214, “Physical layer procedures for data,” December 2022, hereinafter referenced as [1]. For NR Rel. 15 Type-II codebook, the gNB is equipped with a two-dimensional (2D) antenna array with N₁N₂ antenna ports per polarization (N₁ being the horizontal and N₂ the vertical dimension of the array). In the frequency domain, communication occurs over N₃ precoder matrix indicator (PMI) sub-bands, where a sub-band consists of a set of resource blocks (RBs), each RB consisting of a set of subcarriers. Considering dual-polarization, there are 2N₁N₂ CSI-reference signal (RS) ports that are utilized to enable downlink (DL) channel estimation with high resolution for NR Rel. 15 Type-II codebook. In order to reduce feedback overhead in Uplink (UL), a DFT-based transformation is used to project the channel onto L spatial beams (shared by both polarizations) where L<N₁N₂. In the sequel, the indices of the L beams are referred as the Spatial Domain (SD) basis indices. The magnitude and phase values of the 2L linear combination coefficients for each sub-band are fed back to the gNB as part of the CSI report. The 2N₁N₂×N₃ codebook per layer/takes on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the Superscript ^{T} denotes a matrix transposition operation. It is to be noted that O₁, O₂ are “oversampling factors”, assumed for the 2D DFT matrix from which matrix B is drawn. Additionally, W₁ is common across all layers. W_{2,l} is a 2L×N₃ matrix, where the i^{th} column corresponds to the linear combination coefficients of the 2L beams in the i^{th} sub-band. Only the indices of the L selected columns in B are reported, along with the oversampling index taking on O₁O₂ values. It is to be noted that W_{2,l} are independent across different layers.

For NR Rel. 15 Type-II Port Selection Codebook, only K (where K≤2N₁N₂) beamformed CSI-RS ports are utilized in DL transmission, in order to reduce complexity. The K×N₃ codebook matrix per layer takes on the form

$${W}_{l} = {W}_{1}^{PS} {W}_{2 , l} .$$

Here, W_{2,l} follows the same structure as the conventional NR Rel. 15 Type-II Codebook and are layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{P S} {d}_{PS} , K / 2 )}^{( K / 2 )} & {e}_{mod ( {m}_{P S} {d}_{PS} + 1 , K / 2 )}^{( K / 2 )} & … & {e}_{mod ( {m}_{P S} {d}_{P S} + L - 1 , K / 2 )}^{( K / 2 )}\end{matrix} ] ,$$

where

$${e}_{i}^{( K )}$$

is a standard unit vector with a 1 at the i^{th} location. Here d_{PS} is a radio resource control (RRC) parameter which takes on the values {1,2,3,4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the UL CSI feedback report.

$${W}_{1}^{PS}$$

is common across all layers.

For K=16, L=4 and d_{PS}=1, the 8 possible realizations of E corresponding to m_{PS}={0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

$$When {d}_{PS} = 2 , the 4 possible realizations of E corresponding to$$

$${m}_{PS} = \{ 0 , 1 , 2 , 3 \} are as follows$$

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

$$When {d}_{PS} = 3 , the 3 possible realizations of E corresponding of$$

$${m}_{PS} = \{ 0 , 1 , 2 \} are as follows$$

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

$$When {d}_{PS} = 4 , the 2 possible realizations of E corresponding of$$

$${m}_{PS} = \{ 0 , 1 \} are as follows$$

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook is the baseline codebook for NR, with a variety of configurations. One utility of Rel. 15 Type-I codebook is a special case of NR Rel. 15 Type-II codebook with L=1 for rank indicator (RI)-1,2, where a phase coupling value is reported for each sub-band, e.g., W_{2,l} is 2×N₃, with the first row equal to [1, 1, . . . , 1] and the second row equal to [e^{j2πØ}^{₀}, . . . , e^{jπnØ}^{_{N3-1}}]. Under specific configurations, φ₀=φ₁ . . . =φ, e.g., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only. More details on NR Rel. 15 Type-I codebook can be found in R1-1709232, Samsung et al., “WF on Type I and II CSI codebooks,” Hangzhou, China, May 15-19, 2017, hereinafter referenced as [2].

For NR Rel. 16 Type-II Codebook, the gNB is equipped with a two-dimensional (2D) antenna array with N₁N₂ antenna ports per polarization (N₁ being the horizontal and N₂ the vertical dimension of the array). In the frequency domain, communication occurs over N₃ PMI sub-bands, where a sub-band consists of a set of RBs, each RB consisting of a set of subcarriers. Considering dual-polarization, there are 2N₁N₂ CSI-RS ports are utilized to enable DL channel estimation with high resolution for NR Rel. 16 Type-II codebook. In order to reduce feedback overhead in Uplink (UL), a DFT-based transformation is used to project the channel onto L spatial beams (shared by both polarizations) where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. It is to be noted that 01, 02 oversampling factors are assumed for the 2D DFT matrix from which matrix B is drawn. Additionally, W₁ is common across all layers. W_{f,l} is an N_{3X}M matrix (M<N₃) with columns selected from a critically-sampled size-N₃ DFT matrix, as follows:

$${w}_{{f}_{Reject} l} = [ {f}_{{k}_{0}} {f}_{{k}_{1}} {f}_{{k}_{M r - 1}} ] , 0 \leq {k}_{i} \leq {N}_{3} - 1 ,$$

$${f}_{k} = {[}_{1} {e}^{- j \frac{2 π k}{{N}_{3}}} {e}^{{- j \frac{2 π k ( {N}_{3} - 1 )}{{N}_{3}} ]}^{T}}$$

Only the indices of the L selected columns of B may be reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, and We are selected independently for different layers. Amplitude and phase values of an approximately β fraction of the 2LM available coefficients are reported to the gNB (β<1) as part of the CSI report. It is to be noted that coefficients with zero amplitude values are indicated via a layer-specific bitmap matrix Sₗ of size 2L×M, where each bit of the bitmap matrix Sₗ indicates whether a coefficient has a zero-amplitude value, where for these coefficients no quantized amplitude and phase values may be reported. Since all non-zero coefficients reported within a layer are normalized with respect to the coefficient with the largest amplitude value (strongest coefficient), where the amplitude and phase values corresponding to the strongest coefficient are set to one and zero, respectively, and hence no further amplitude and phase information is explicitly reported for this coefficient, and only an indication of the index of the strongest coefficient per layer is reported. Hence, for a single-layer transmission, amplitude, and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

For NR Rel. 16 Type-II Port Selection Codebook, only K (where K≤2N₁N₂) beamformed CSI-RS ports are utilized in DL transmission, in order to reduce complexity. The K×N₃ codebook matrix per layer takes on the form as discussed in [1].

$${W}_{l} = {W}_{1}^{PS} {\tilde{W}}_{2 , l} {W}_{f , l}^{H} .$$

Here, \tilde{W}_{2,l} and W_{f,l} follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II Port Selection Codebook.

The NR Rel. 17 Type-II Port Selection Codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, \tilde{W}_{2,l} and W_{f,l} follow the same structure as the conventional NR Rel. 16 Type-II Codebook, however Mis limited to {1,2} only, with the network configuring a window of size N∈{2,4} for M=2. Moreover, the bitmap is reported unless β=1 and the UE reports all the coefficients for a rank up to a value of two.

For Rel-18 potential Type-II codebook, the time-domain corresponding to slots is further compressed via DFT-based transformation, where the codebook is in the following form

$${W}_{l} = {W}_{1} {{\tilde{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically-sampled size-N4 DFT matrix, as follows

$${W}_{d , l} = \begin{matrix}[ {d}_{q 0} & {d}_{q 1} & … & {d}_{{q}_{Q - 1}} ] , 0 \leq {q}_{i} \leq {N}_{4} - 1 ,\end{matrix}$$

$${d}_{q} = {[ \begin{matrix}1 & {e}^{- j \frac{2 π q}{{N}_{4}}} & … & {e}^{- j \frac{2 π q ( {N}_{4} - 1 )}{{N}_{4}}}\end{matrix} ]}^{T} .$$

Only the indices of the Q selected columns of W_{d,l} are reported. It is to be noted that that W_{d,l} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may be reported associated with Rel-18 Type-II codebook.

For CSI reporting the codebook report is partitioned into two parts based on the priority of information reported. Each part is encoded separately (Part 1 has a possibly higher code rate). Below we list the parameters for NR Rel. 16 Type-II codebook only. More details can be found in clause 5.2.3-4 of [1].

For content of a CSI report:
Part 1: RI+channel quality indicator (CQI)+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can be performed to allow dynamic reporting size for codebook based on available resources in the uplink phase. More details can be found in clause 5.2.3 of [1].

Also, Type-II codebook is based on aperiodic CSI reporting, and only reported in PUSCH via downlink control information (DCI) triggering (one exception). Type-I codebook can be based on periodic CSI reporting (e.g., physical uplink control channel (PUCCH)) or semi-persistent CSI reporting (PUSCH or PUCCH) or aperiodic reporting (PUSCH).

For triggering aperiodic CSI reporting on PUSCH, a UE is to report CSI information for the network using the CSI framework in NR Release 15. The triggering mechanism between a report setting and a resource setting can be summarized in Table 1 below.

TABLE 1

| | | | | Access |
|---|---|---|---|---|
| | | | Semi- | Point |
| | | Periodic | Persistent | (AP) |
| | | CSI | (SP) CSI | CSI |
| | | reporting | reporting | Reporting |
| Time | Periodic | RRC | medium access | DCI |
| Domain | CSI-RS | configured | control (MAC) | |
| Behavior of | | | control element | |
| Resource | | | (CE) (PUCCH) | |
| Setting | | | DCI (PUSCH) | |
| | SP CSI-RS | Not Supported | MAC CE | DCI |
| | | | (PUCCH) | |
| | | | DCI (PUSCH) | |
| | AP CSI-RS | Not Supported | Not Supported | DCI |

Further, associated Resource Settings for a CSI Report Setting may have a same time domain behavior. Periodic CSI-RS/interference management (IM) resource and CSI reports can be assumed to be present and active once configured by RRC. Aperiodic and semi-persistent CSI-RS/IM resources and CSI reports can be explicitly triggered or activated. For aperiodic CSI-RS/IM resources and aperiodic CSI reports, triggering can be done jointly by transmitting a DCI Format 0-1. Semi-persistent CSI-RS/IM resources and semi-persistent CSI reports can be independently activated.

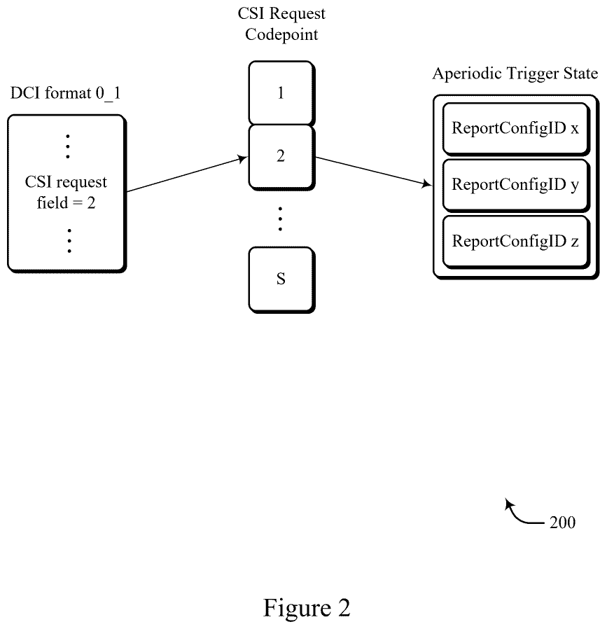

FIG. 2 illustrates a scenario 200 for aperiodic trigger state defining a list of CSI report settings. For aperiodic CSI-RS/IM resources and aperiodic CSI reports, the triggering can be performed jointly by transmitting a DCI Format 0_1. The DCI Format 0_1 can include a CSI request field, e.g., 0 to 6 bits. A non-zero CSI request field can point to the aperiodic trigger state configured by RRC. An aperiodic trigger state can be defined as a list of up to 16 aperiodic CSI report settings, identified by a CSI report setting ID (“ReportConfigID”) for which the UE calculates CSI and transmits the CSI on a scheduled PUSCH transmission.

When the CSI report setting is linked with aperiodic resource setting (e.g., including multiple resource sets), the aperiodic NZP CSI-RS resource set for channel measurement, the aperiodic CSI-IM resource set, and the aperiodic NZP CSI-RS resource set for IM to use for a given CSI report setting can also be included in the aperiodic trigger state definition. For aperiodic NZP CSI-RS, the quasi co-location (QCL) source to use can also be configured in the aperiodic trigger state. A UE can determine that the resources used for the computation of the channel and interference can be processed with the same spatial filter e.g. QCL'd with respect to QCL-TypeD. With reference to the present disclosure, CSI report settings can be used by a UE to generate and transmit CSI reports to NE regarding occurrence of near field events, beam identifiers, beam measurement indicators (e.g., beam quality values), etc.

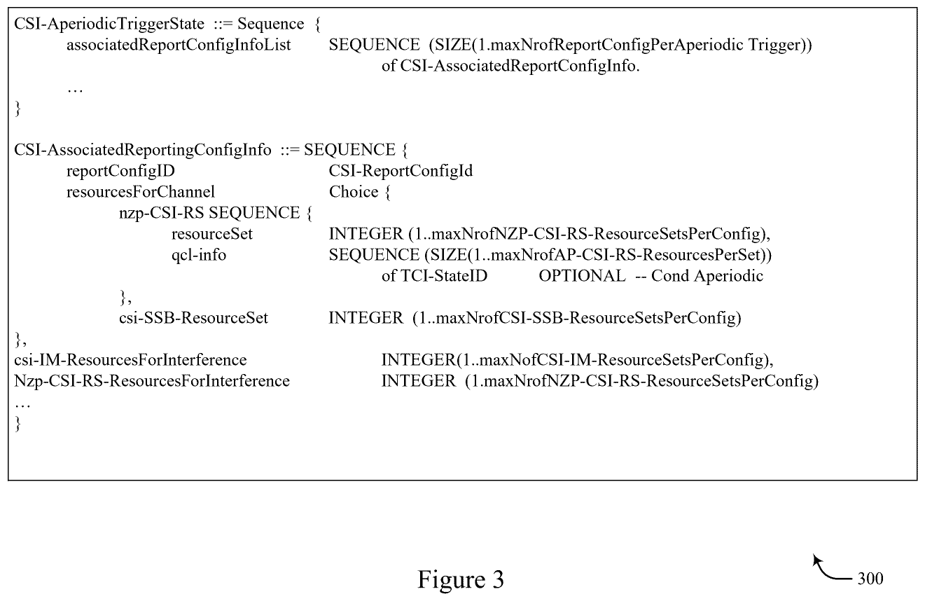

FIG. 3 illustrates aperiodic trigger state 300 indicating a resource set and QCL information. The aperiodic trigger state 300, for example, can be utilized for configuring CSI reported by UE. With reference to the present disclosure, the aperiodic trigger state 300 can be used by a UE to generate and transmit CSI reports to NE regarding occurrence of near field events, beam identifiers, beam measurement indicators (e.g., beam quality values), etc.

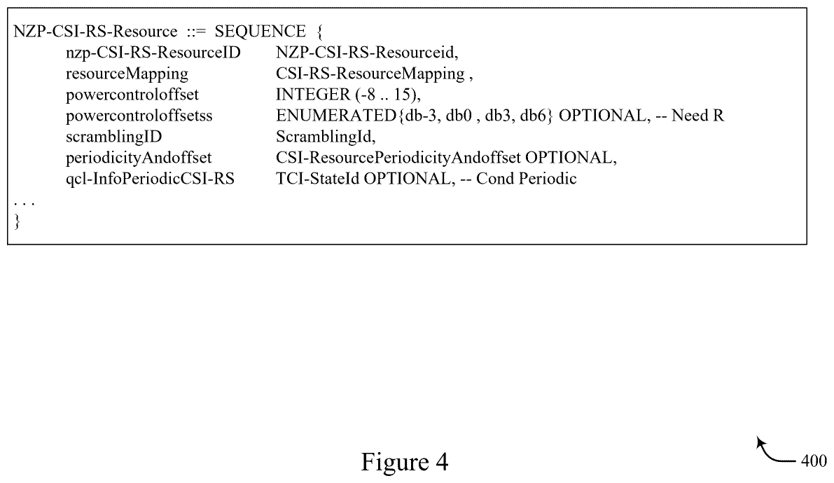

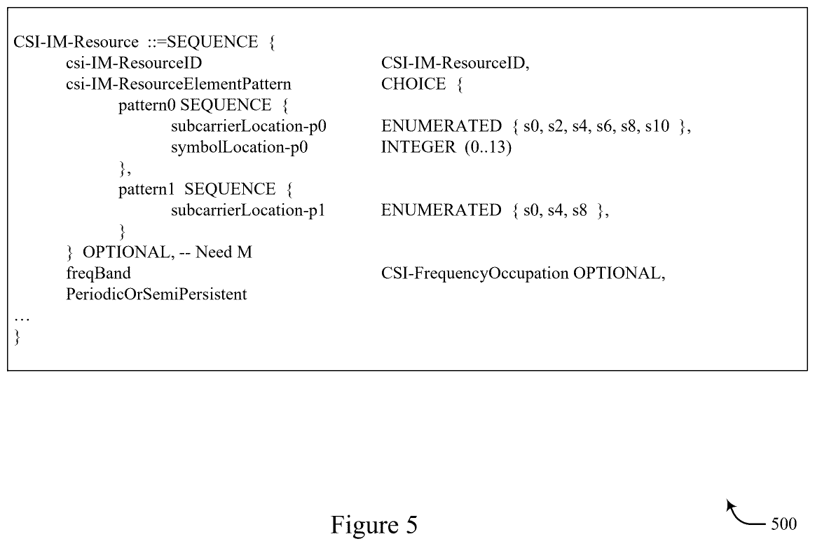

FIG. 4 illustrates RRC configuration 400 for NZP-CSI-RS and FIG. 5 illustrates RRC configuration 500 for CSI-IM resources. In implementations, the RRC configuration 400 can be used by a UE to identify NZP-CSI-RS resources, such as NZP-CSI-RS resources that correspond to beams that the UE receives and measures for determining whether near field events occur, as described throughout this disclosure. The RRC configuration 500 can be used to identify interference management resources, such as for identifying and managing signal interference between an NE and a UE.

For aperiodic CSI reporting, PUSCH-based reports can be divided into two CSI parts: CSI Part1 and CSI Part 2. The size of CSI payloads can vary significantly, and therefore an uplink control information (UCI) payload size design may result in large overhead. CSI Part 1 has a fixed payload size (and can be decoded by the gNB without prior information) and includes the following: RI (if reported), CSI-RS Resource Index (CRI)) (if reported) and CQI for the first codeword; number of non-zero wideband amplitude coefficients per layer for Type II CSI feedback on PUSCH.

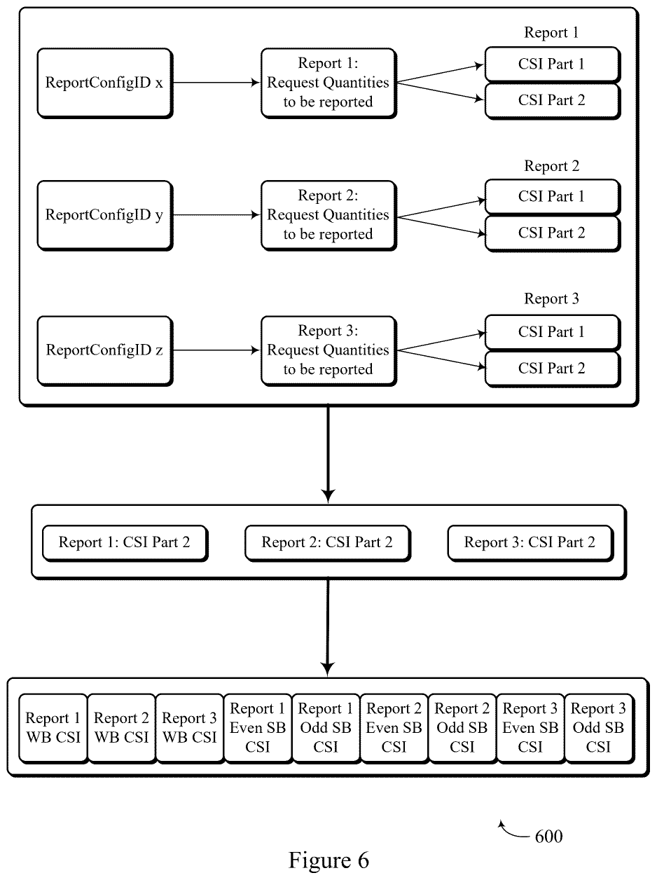

FIG. 6 illustrates a scenario 600 for partial CSI omission. The scenario 600, for example, illustrates a packing order of CSI parts within the CSI report to be transmitted within the UCI. The CSI measured from one or more reference signals is mapped to one or more CSI reports, where the packing of the CSI is as illustrated. In the scenario 600, CSI Part 2 has a variable payload size that can be derived from the CSI parameters in CSI Part 1 and can include PMI and the CQI for the second codeword when RI>4. For example, if the aperiodic trigger state indicated by DCI format 0_1 defines 3 report settings (“ReportConfigIDs”) x, y, and z, the aperiodic CSI reporting for CSI part 2 can be ordered as indicated in the scenario 600. The scenario 600 includes reports for wide-band (“WB”) and sub-band (“SB”).

CSI reports can be prioritized according to (1) time-domain behavior and physical channel, where more dynamic reports are given precedence over less dynamic reports and PUSCH has precedence over PUCCH; (2) CSI content, where beam reports (e.g., L1-RSRP reporting) may have priority over regular CSI reports; (3) the serving cell to which the CSI corresponds (in case of carrier aggregation (CA) operation)-CSI corresponding to the PCell may have priority over CSI corresponding to Scells; (4) the reportConfigID.

Codebook Subset Restriction (CBSR) has been supported for NR Rel. 15 Type-I and Type-II CSI for controlling inter-cell interference levels. In Type-I CBSR, a size N₁N₂O₁O₂ bitmap is used to indicate the restricted beam, where N₁/N₂ and O₁/O₂ indicate the number of horizontal/vertical ports and horizontal/vertical oversampling factors, respectively. Each bit in the sequence is used to restrict a certain DFT beam for a given oversampling index.

The bitmap parameter typel-SinglePanel-codebookSubsetRestriction-i2 forms the bit sequence b₁₅, . . . , b₁, b₀ where b₀ is the least significant bit (LSB) and b₁₅ is the most significant bit (MSB). The bit bᵢ is associated with precoders corresponding to codebook index i₂=i. When bᵢ is zero, the randomly selected precoder for CQI calculation is not allowed to correspond to any precoder associated with the bit bᵢ.

In Type-II CBSR, instead of a hard restriction decision, i.e., a DFT beam within an oversampling index is either fully prohibited or unrestrictedly available, an amplitude restriction is further imposed as follows: (1) The N₁N₂O₁O₂ candidate DFT beams are re-grouped into O₁O₂ beam groups (beams within a beam group may not belong to the same oversampling index); (2) Beam restriction is only allowed on 4 out of the O₁O₂ beam groups, i.e.,

$$⌈ {log}_{2} {C}_{4}^{{O}_{1} {O}_{2}} ⌉$$

bits are used to indicate the restricted beam groups; (3) For the 4N₁N₂ restricted beams across the 4 beam groups, 2 bits are allocated per beam to indicate the restriction on the maximum allowed amplitude value from a codebook of amplitude value restrictions, where the amplitude restriction,

$$Amp . = \{ 1 , {( \frac{1}{2} )}^{\frac{1}{2}} , {( \frac{1}{4} )}^{\frac{1}{2}} , 0 \} ,$$

i.e., −3 dB step size per restriction value in power domain. Hence, 8N₁N₂ bits can be used to report the amplitude restrictions for the 4 restricted beam groups based on Type-II soft restriction.

The bitmap parameter n1-n2-codebookSubsetRestriction-r16 forms the bit sequence B=B₁B₂ and configures the vector group indices g^{(k)} as in clause 5.2.2.2.3. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, γ_{i=pL} (p=0,1), with i∈{0, 1, . . . , L−1} corresponding to a beam index, of the coefficients associated with the vector in group g (k) indexed by x1, x2, where the maximum amplitudes are given in Error! Reference source not found. and the average coefficient amplitude is restricted as follows

$$\sqrt{\frac{1}{{\sum }_{f = 0}^{{M}_{v} - 1} {k}_{l , i + pL , f}^{( 3 )}} {\sum }_{f = 0}^{{M}_{v} - 1} {{k}_{l , i + pL , f}^{( 3 )} ( {p}_{l , p}^{( 1 )} {p}_{l , i + pL , f}^{( 2 )} )}^{2}} \leq {γ}_{i + pL}$$

for l=1, . . . , v, is a layer index, f∈{0, 1, . . . , Mᵥ−1} is a frequency-domain basis index, and p=0,1 is a polarization index. A UE that does not report the parameter softAmpRestriction-r16=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01$$

or 10.

TABLE 2

| | Maximum |
|---|---|
| | Average |
| | Coefficient |
| $Bit {b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Amplitude γ_{i+pL} |
| 00 | 0 |
| 01 | \sqrt{1/4} |
| 10 | \sqrt{1/2} |
| 11 | 1 |

For near-field channel modelling, zones have been defined relative to a NE (e.g., base station), including a Fresnel zone with evanescent waves (non-uniform spherical waves) where a UE is within 0.63\sqrt{D³/λ} m from the NE, where D is the antenna aperture size, and A is the wavelength corresponding to an operating frequency. A Rayleigh/Fraunhofer zone is defined as a zone with uniform spherical waves where a UE is within 2cD²/λ m from the network entity, where c is a constant, e.g., c=0.4. A far field zone can be defined as a zone with planar waves where a UE is farther than 2cD²/λ m from the NE. In implementations, the Fresnel zone represents a near-field with reference to a UE relative to a NE.

For initial access procedures for a UE to obtain cell access (e.g., to an NE), the UE can engage in multiple phases corresponding to multiple messages from the UE to the NE and vice versa, such as described in Table 3.

TABLE 3

| Process | Functionality | Description |
|---|---|---|
| P0 | SS/PBCH reception | The UE receives synchronization signal (SS)/PBCH from |
| | | the network entity, corresponding to one or more SSB |
| | | resources. The UE aims at receiving at least one of the |
| | | SSBs. |
| P1 | RACH preamble transmission | The UE transmits a RACH preamble (physical random |
| msg1 | | access channel (PRACH)) to the network entity from a set |
| | | of available RACH preambles, the transmitted RACH |
| | | preamble is mapped to a selected SSB, e.g., the selected |
| | | SSB is the received SSB with the highest RSRP value. |
| P2 | Random access response (RAR) | The UE receives a RAR from the network entity that |
| msg2 | reception | verifies the reception of the RACH preamble from the UE, |
| | | as well as provides an UL grant to the UE for uplink |
| | | transmission of a following msg3 signal |
| P3 | UL PUSCH transmission | The UE transmits an UL PUSCH signal to the network that |
| msg3 | | carries RRC parameters or possibly some physical layer |
| | | parameters as well. |
| P4 | Contention resolution | After transmitting msg3, the UE is expected to receive |
| msg4 | | msg4 from the network entity, confirming that the UE has |
| | | verified connection with the UE, as well as provide a Cell |
| | | radio network temporary identifier (RNTI) to the UE. |

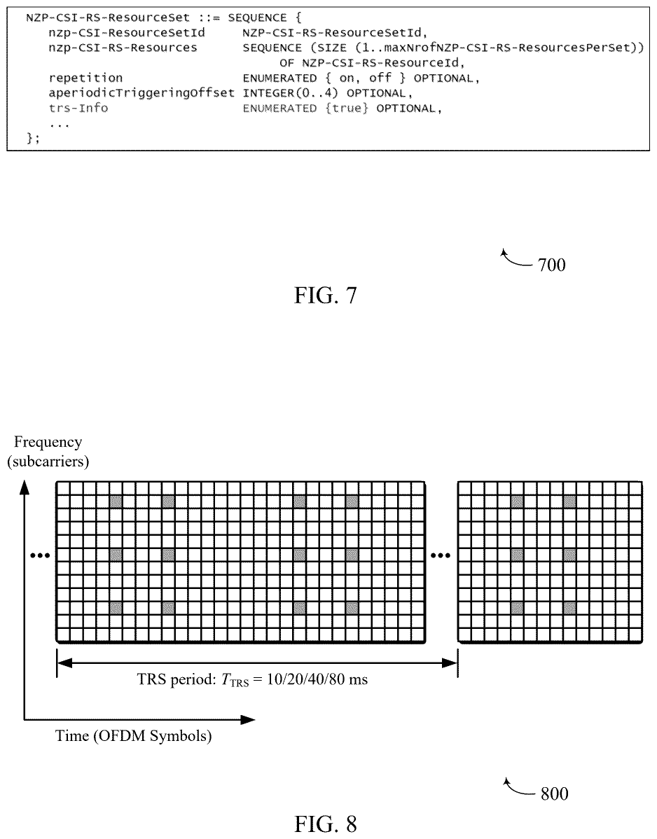

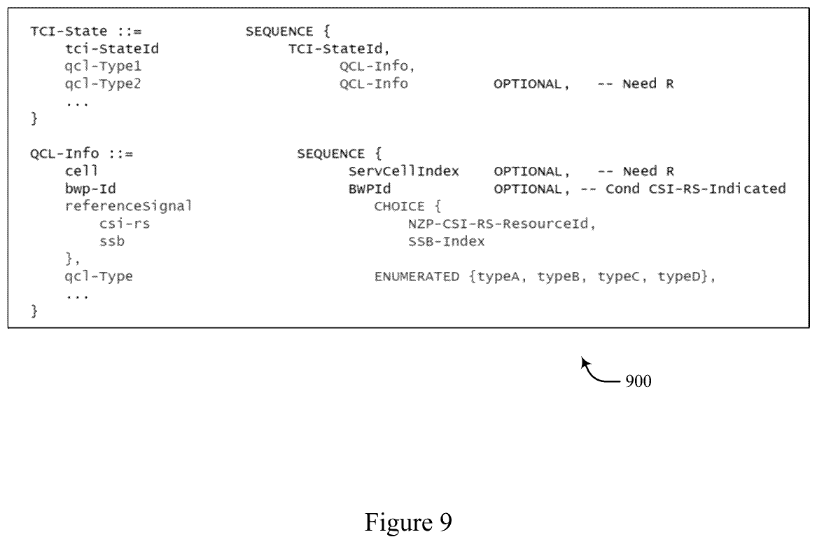

FIG. 7 illustrates example information element 700 for configuring an NZP-CSI-RS resource set. The information element 700, for instance, represents abstract syntax notation (ASN)-1 code that pertains to multi-resolution precoding based on multiple submatrices in accordance with aspects of the present disclosure. Tracking reference signal (TRS) can be transmitted for establishing fine time and frequency synchronization at a UE to aid in demodulation of physical downlink shared channel (PDSCH), particularly for higher order modulations. A TRS is an NZP CSI-RS resource set with “TRS-info” set to true. As shown in the information element 700, “trs-info” indicates that the antenna port for all NZP-CSI-RS resources in the CSI-RS resource set is the same. The TRS includes either 2 or 4 periodic CSI-RS resources with periodicity 2^{-μ}*Xp slots where Xp=10, 20, 40, or 80 and where u is related to the sub carrier spacing (SCS), e.g. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 8. In implementations, the information element 700 can be used by a UE to identify NZP-CSI-RS resources, such as NZP-CSI-RS resources that correspond to beams that the UE receives and measures for determining whether near field events occur, as described throughout this disclosure.

FIG. 8 illustrates an example TRS configuration 800, as related to multi-resolution precoding based on multiple submatrices in accordance with aspects of the present disclosure. A TRS represents a type of CSI-RS, which in some scenarios can be used for channel measurements. For instance, the UE may be configured with multiple TRSs, where each TRS is associated with a subarray of multiple subarrays of an antenna array at the network equipment. In the TRS configuration 800, the two CSI-RS within a slot are separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set {1 to 8}. The maximum number of TRS resource sets configured to UE per CC: Candidate value set: {1 to 64}. The UE may report at least 8 for FR1 and 16 for FR2. The maximum number of TRS resource sets configured to UE across CCs: Candidate value set: {1 to 256}. The UE may report at least 16 for FR1 and 32 for FR2. Furthermore, an aperiodic TRS is a set of aperiodic CSI-RS for tracking that is optionally configured, but a periodic TRS may be configured, and its time and frequency domain configurations (except for the periodicity) may match those of the periodic TRS. The UE may assume that the aperiodic TRS resources are QCL'd with the periodic TRS resources.

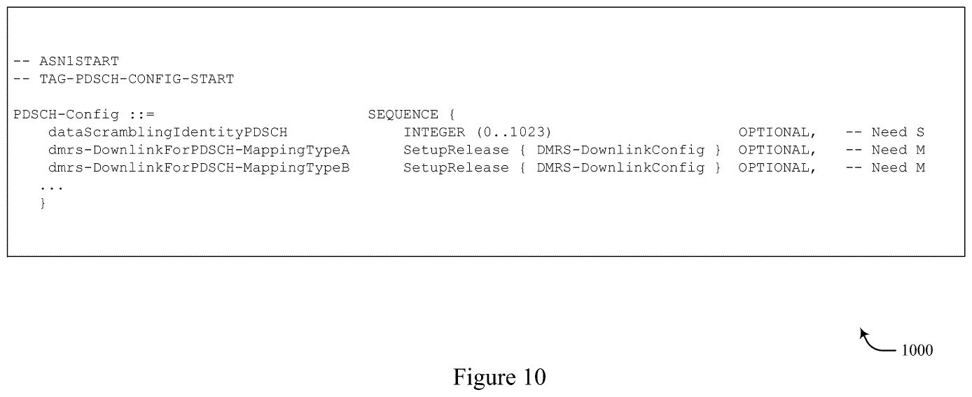

FIG. 9 illustrates an example information element 900. The information element 900, for instance, includes ASN-1 code for QCL information, as related to multi-resolution precoding based on multiple submatrices in accordance with aspects of the present disclosure. In the information element 900, a transmission configuration indicator (TCI) state (e.g., as configured by RRC) may have two QCL types (e.g., two reference signals) with the second QCL type for operation in FR2.

With reference to DMRS and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a SSB block. The DMRS is used to estimate channel coefficients for coherent detection of the physical channels. For downlink, the DMRS is subject to the same precoding as the PDSCH. NR first defines two time-domain structures for DMRS according to the location of the first DMRS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the code-division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

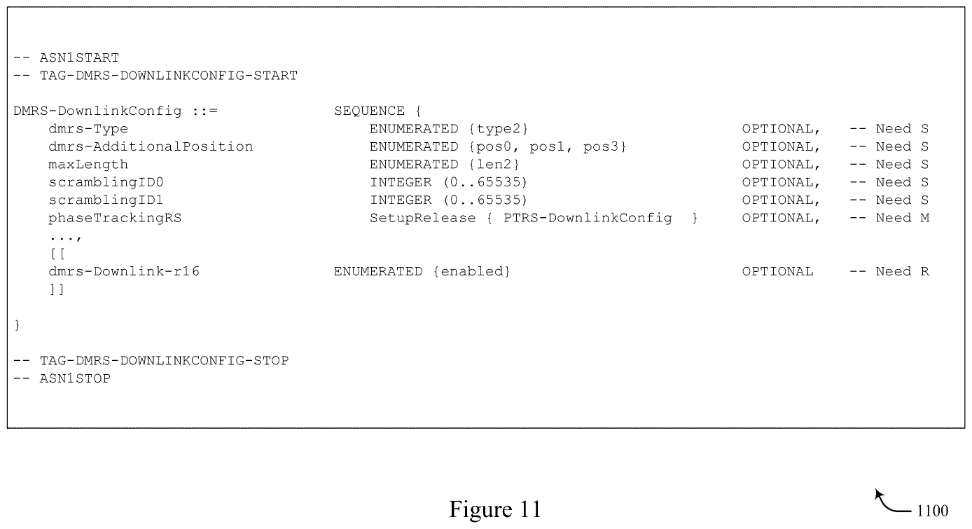

FIG. 10 illustrates an example information element 1000. The information element 1000, for instance, includes ASN-1 code for a PDSCH-Config information element, as related to multi-resolution precoding based on multiple submatrices in accordance with aspects of the present disclosure. In the information element 1000, the configuration of the DMRS Type is provided through higher-layer signaling independently for each PDSCH and PUSCH, each mapping Type (A or B), and each bandwidth part (BWP) independently (see the RRC configuration). The PDSCH-Config information element (e.g., as shown in the information element 1000) can be used to configure the UE specific PDSCH parameters.

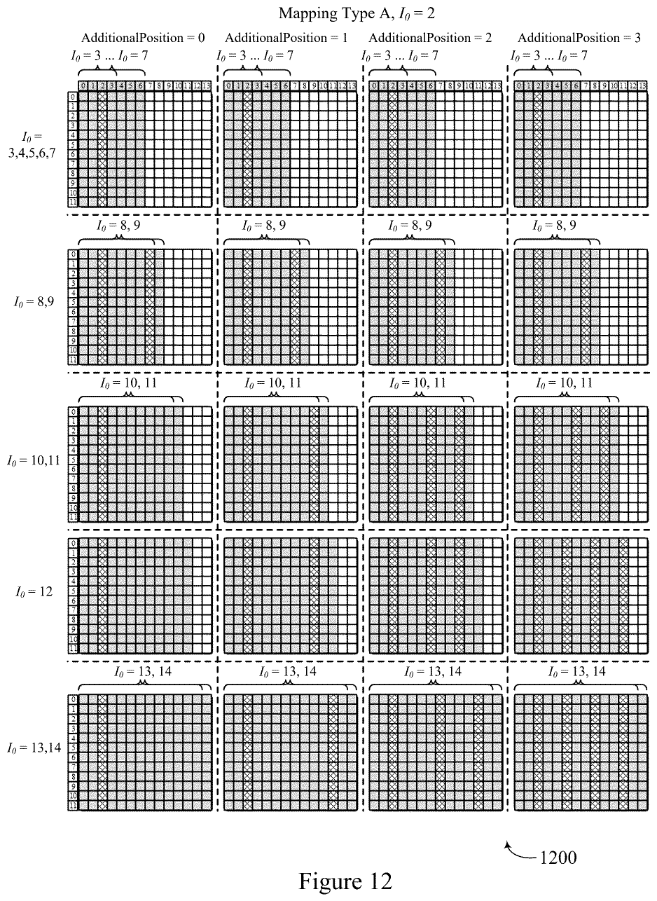

FIG. 11 illustrates an example information element 1100. The information element 1000, for instance, includes ASN-1 code for DMRS-DownlinkConfig, as related to multi-resolution precoding based on multiple submatrices in accordance with aspects of the present disclosure. In the information element 1100, the information element DMRS-DownlinkConfig can be used to configure downlink demodulation reference signals for PDSCH.

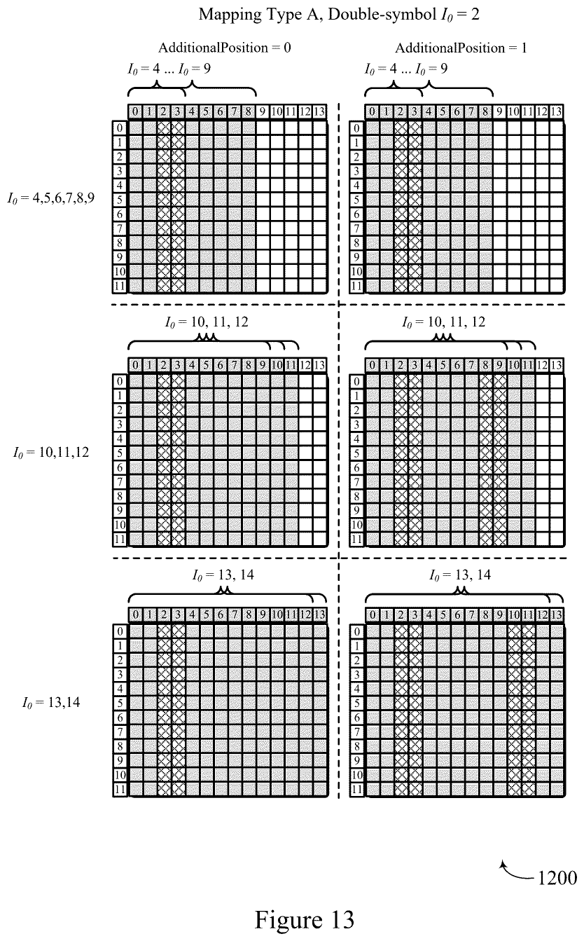

FIGS. 12 and 13 illustrate an example 1200 of DMRS patterns for mapping Type A with front-load DMRS, as related to multi-resolution precoding based on multiple submatrices in accordance with aspects of the present disclosure. The DMRS, for example, is associated with a DL data signal (e.g., DMRS for PDSCH), UL data signal (e.g., DMRS for PUSCH), or DL control signal, e.g., DMRS for PDCCH. A DMRS for PDSCH may be mutually QCLed with multiple RSs associated with the multiple antenna subarrays of an antenna array at the network equipment.

In the example 1200, the time domain mapping of the DMRS patterns can be decomposed to two parts. For example, the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to 4 DMRS symbols. The location of the DMRS is defined by both higher-layer configuration and dynamic (DCI-based) signaling, such as dmrs-TypeA-Position, maxLength, and dmrs-AdditionalPosition. When double-symbol DMRS is used, there can be up to one more double-symbol DMRS (total 4 DMRS symbols inside the PDSCH allocation). Different DMRS patterns for mapping Type A with front-load DMRS are shown in the example 1200.

In the absence of CSI-RS configuration, and unless otherwise configured, the UE may assume PDSCH DMRS and SS/physical broadcast channel (PBCH) block antenna ports are QCL'd with respect to Doppler shift, Doppler spread, average delay, delay spread, and spatial Rx parameters (if applicable). However, a CSI-RS for tracking can be used as a QCL reference (e.g., having larger bandwidth than an SS/PBCH block). Furthermore, the UE may assume that the PDSCH DMRS within the same CDM group are QCL'd with respect to Doppler shift, Doppler spread, average delay, delay spread, and spatial Rx. The UE may then perform a joint estimation of DMRS ports which are CDMed using the same long-term statistics, the UE may not measure, or use, different long-term statistics for different DMRS ports of the same PDSCH.

The following discusses antenna panel/port, QCL, TCI state, and spatial relation. In some implementations, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, etc., may or may not be transparent to other devices. In some implementations, capability information may be communicated via signaling or, in some implementations, capability information may be provided to devices without signaling. In the case that such information is available to other devices, it can be used for signaling or local decision making.

In some implementations, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel involves biasing or powering on of the RF chain which results in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be QCL'd if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be QCL'd with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

QCL-TypeA, QCL-TypeB and QCL-TypeC may be applicable for all carrier frequencies, but the QCL-TypeD may be applicable only in higher carrier frequencies (e.g., mmWave, FR2 and beyond), where the UE may not be able to perform omni-directional transmission, e.g. the UE may form beams for directional transmission. A QCL-TypeD between two reference signals A and B, the reference signal A is considered to be spatially co-located with reference signal B and the UE may assume that the reference signals A and B can be received with the same spatial filter (e.g., with the same receiver beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a Transmission Configuration Indication (TCI) state associated with a target transmission can indicate parameters for configuring a QCL relationship between the target transmission (e.g., target RS of DMRS ports of the target transmission during a transmission occasion) and a source reference signal(s) (e.g., SSB/CSI-RS/sounding reference signal (SRS)) with respect to QCL type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Implementations for event information for a near field event are described herein. In the discussion herein, the following notions can be used interchangeably: network nodes, transmit-receive point (TRP), panel, set of antennas, set of antenna ports, uniform linear array, cell, node, radio head, communication (e.g., signals/channels) associated with a CORESET (control resource set) pool, and communication associated with a TCI state from a transmission configuration including at least two TCI states. A TRS can represent an NZP CSI-RS resource set with a parameter ‘trs-info’ being configured. A CSI-RS for beam management can represent an NZP CSI-RS resource set with a parameter ‘repetition’ being configured. A CSI-RS for CSI corresponds to an NZP CSI-RS resource set with neither parameters ‘trs-info’ nor ‘repetition’ being configured. A matrix can represent a sequence of fields of an arbitrary dimension, including an array (vector) of values, a standard 2D matrix, and/or a Q-dimensional matrix (tensor) where Q≥2 is an integer value. A mapping between a transport block and a codeword transmitted in DL can be based on a one-to-one mapping between the TBs and codewords. Multiple implementations are described herein and one or more elements or features from one or more of the described implementations may be combined.

Implementations herein include multiple (e.g., two or more) sets of beams corresponding to near field and far field beamforming. For instance, two stage beam management can be implemented where based on CSI reporting in a first stage, a NE may configure a second state of beam management. For instance, a UE can be configured to receive two sets of beams where a first set of beams is associated with far field beams (e.g., DFT beams) and is received at the UE in a first transmission. The first set of beams can be received over a first time interval and the UE can select a first subset of the first set of beams.

Following selection of the first subset of the first set of beams, the UE can report indices of the selected first subset of the first beams to the NE in a second time interval, where the second time interval succeeds the first time interval. The UE can receive one or more second subsets of a second set of beams that are associated with near field beams over a third time interval which can succeed the second time interval. The second set of beams can include multiple second subsets of beams where each second subset of beams is associated with a selected beam in the first set of beams. In an example, each beam in the second set of beams is associated with a target distance, depth, and focal distance, e.g., codepoints of a polar codebook.

In implementations, the UE receiving a second subset of the second set of beams can be conditioned on reported beam indices and their corresponding beam quality values reported in the second time interval. The beam quality values, for instance, may correspond to RSRP or SINR values. A condition applied to the reported beam indices may correspond to the UE reporting a flag value corresponding to an event identified or configured by the network, and the event may correspond to a difference in beam quality values corresponding to multiple beams being smaller than a configured value range. In implementations, the reception of the second subset of the second set of beams can occur after a reception of the first set of beams.

In implementations, the UE can select one or more beams in the second subset of the second set of beams. The UE can report an indication of the selected one or beams in the second subset of the second set of beams, the reporting can be over a fourth time interval, and the fourth time interval can succeed the third time interval. Such implementations can be applied to more than two sets of beams (e.g., K>2 sets of beams), where multiple sets of beams are received over multiple time intervals (e.g., K time intervals) and the UE reports indications of selections of beams over multiple time intervals (e.g., K time intervals) for a duration of 2K time intervals.

In implementations, a UE can be configured to receive, from a NE, two sets of beams, where a first set of beams corresponds to near field and a second set of beams is associated with far field. For example, the two sets of beams can be transmitted and/or received simultaneously and/or concurrently. A UE may report a far field beam and beam grouping between near field and far field beams can be specified. The UE, for instance, is configured with receiving two sets of beams where a first set of beams is associated with far field beams (e.g., DFT beams) and is received at the UE in a first transmission. A second set of beams is associated with near field beams and each beam in the second set of beams is associated with a distinct phase, as well as at least one of a target distance, depth, or focal distance. In implementations the two sets of beams can be received over a first time interval. The UE can select a first subset of beams from at least one of the first set of the first beams or the second set of second beams. The selected first subset of beams may include an indication of at least one beam from the first set of beams. Alternatively, or in addition, the first subset of beams may include a first indication of at least a first beam from the first set of beams and a second indication of at least a second beam from a second set of beams. The UE can report the indication of the selected subset(s) of beams to the NE.

Implementations also provide for identification of near field UEs based on subarray-based beamforming. Regarding antenna correspondence to subarrays, a subarray may be multiple antenna elements, a subarray may be multiple ports, and/or a subarray may be a distinct node. A UE can be configured with receiving multiple sets of beams based on a configuration. The multiple sets of beams may correspond to a plurality of antenna subarrays of an antenna array at an NE. In at least one example, each antenna subarray can be associated with a group of antenna elements of the antenna array at the network node, where the association may be in a one-to-one fashion. In at least another example, each antenna subarray can be associated with a group of antenna ports of the antenna array, where the association may be in a one-to-one fashion.

A mapping of each set of beams in the multiple sets of beams with an antenna subarray in multiple antenna subarrays can be indicated to the UE, via either implicit mapping or explicit mapping. Implicit mapping may be based on a monotonic mapping of a beam set ID and an antenna subarray ID, where the antenna subarray ID may be based on a group of ID values of corresponding antenna ports in the antenna array. Explicit mapping may be based on a predefined table of values or a formula that indicates the mapping, or a higher-layer configuration depicting the mapping. Alternatively, or in addition, the multiple sets of beams may correspond to a plurality of network nodes (e.g., NEs), where the correspondence may be in a one-to-one fashion.

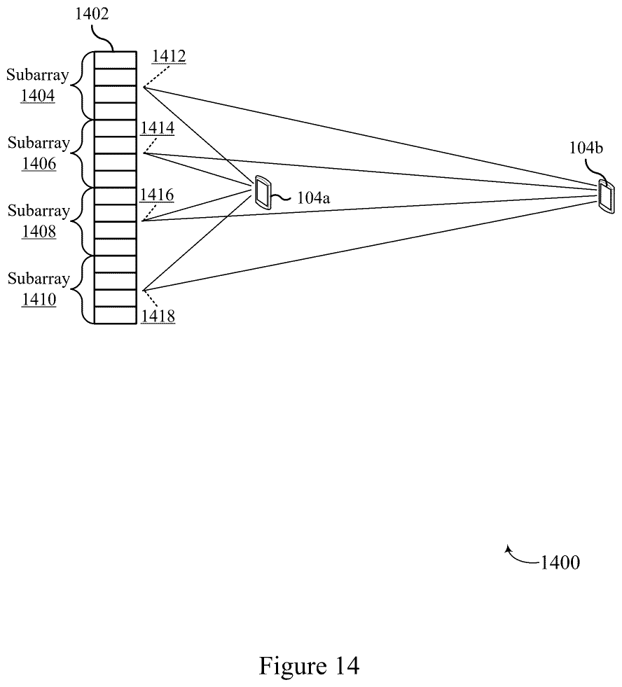

FIG. 14 depicts an example wireless communication system 1400 in accordance with aspects of the present disclosure. The wireless communication system 1400 includes an antenna array 1402 with different antenna subarrays, including a subarray 1404, a subarray 1406, a subarray 1408, and a subarray 1410. The wireless communication system 1400 also includes a UE 104a and a UE 104b. The antenna array 1402 transmits multiple sets of beams and the different subarrays in the antenna array 1402 each transmit different a respective set of beams of the sets of beams. For instance, the subarray 1404 transmits a beam set 1412, the subarray 1406 transmits a beam set 1414, the subarray 1408 transmits a beam set 1416, and the subarray 1410 transmits a beam set 1418.

In implementations, to identify whether a UE is in a near field region, the UE can measure one or more beams over a first set of beams. For instance, the UE 104a can measure beams of the beam set 1412 and compare the measurements to near field criteria, such different thresholds discussed herein. If at least one beam of the beam set 1412 does not meet near field criteria, the UE 104a can be determined to not be located in a near field, e.g., not a near field UE. If at least one beam of the beam set 1412 meets near field criteria, the UE 104a can measure at least one beam per beam set of the beam sets 1414, 1416, 1418, where each beam measured in the beam sets 1414, 1416, 1418 corresponds to the at least one beam from the beam set 1412 that met the near field criteria. For instance, beam indices (e.g., beam identifiers) of beams measured from the beam sets 1414, 1416, 1418 can correspond to a beam index (e.g., beam identifier) of the at least one beam measured from the beam set 1412. If at least one measured beam from the beam sets 1414, 1416, 1418 meets near field criteria, the UE 104a can be determined to be located in a near field relative to the antenna array 1402. If at least one measured beam from the beam sets 1414, 1416, 1418 does not meet near field criteria, the UE 104a can be determined to not be located in a near field relative to the antenna array 1402, e.g., a far field UE. The UE 104b may perform similar operations to the UE 104a, which may indicate that the UE 104b is located in a far field relative to the antenna array 1402, e.g., is a far field UE. In this example, the UE 104a may be determined to be a near field UE, and thus a NE associated with the antenna array 1402 can perform near field beamforming (e.g., piecewise beamforming) for signal transmission between the UE 104a and the antenna array 1402.

In implementations, the UE 104a can measure beam quality values of beams in the beam set 1412, and identify a strongest beam in the beam set 1412, e.g., beam k. If the beam quality value corresponding to the strongest beam (e.g., beam k) meets a first threshold value, the UE 104a can proceed to a next step. If the beam quality value corresponding to the strongest beam (e.g., beam k) does not meet the first threshold value, the UE 104a can be determined to not be a near field UE.

In the next step, where the beam quality value corresponding to the strongest beam (e.g., beam k) meets a first threshold value, the UE 104a can measure beam quality values of the kth beams in the beam sets 1414, 1416, 1418, where the kth beams in the beam sets 1414, 1416, 1418 are resource-wise QCLed. If a difference in the beam quality value of the kth beam in the beam set 1412 and other kth beams in the beam sets 1414, 1416, 1418 meets a threshold (e.g., near field criteria), the UE 104a can be considered to be in a near field region. If a difference in the beam quality value of the kth beam in the beam set 1412 and other kth beams in the beam sets 1414, 1416, 1418 does not meet a threshold (e.g., near field criteria), the UE 104a can be considered to not be in a near field region.

In implementations, a maximum number of sets of beams that a UE is to monitor can be conditioned on at least one of: A maximum number of active RS resources that the UE can monitor simultaneously, e.g., the RS resources are NZP CSI-RS resources; a maximum number of active RS ports that the UE can monitor simultaneously, e.g., the RS port are CSI-RS ports; a maximum number of CPUs corresponding to a maximum number of CSI reports that a UE can simultaneously compute or generate.

In implementations, beam to RS correspondence can be determined in different ways, such as SSB or CSI-RS resource or pool of resources, beams across subarrays belong to a same CDM, a mutual QCL across beam k in beam subset 1 with beam k in other beams subsets, etc. Each set of beams in multiple sets of beams can correspond to at least one of: An NZP CSI-RS resource set including one or more NZP CSI-RS resources, where each NZP CSI-RS resource corresponds to a respective beam; a group of SS/PBCH signals (e.g., SSBs), where each SS/PBCH or SSB resource corresponds to a distinct beam; a configured pool of NZP CSI-RS resources, where each NZP CSI-RS resource corresponds to a respective beam. A plurality of configured pools of NZP CSI-RS resources may correspond to a common NZP CSI-RS resource set; a number of beams per set of beams can be equal across any two or more sets of beams.

Alternatively, or in addition, a mapping of beam indices per set of beams can be consistent across any two sets of beams, e.g., a first beam in a first set of beams is mutually QCLed with a corresponding first beam in a second set of beams, first beam in a third set of beams, etc. Further, a second beam in the first set of beams is mutually QCLed with a corresponding second beam in the second set of beams, second beam in the third set of beams, etc. The QCL may correspond to a strong correlation in an angular domain characteristic, e.g., azimuth angle of departure, zenith angle of departure, or a form of an angle of departure that is not tied to a particular coordinate or direction.

Alternatively, or in addition, NZP CSI-RS resources corresponding to different NZP CSI-RS resource sets may be CDMed within a same CDM group. For instance, a number of the multiple sets of beams can be equal to two, and thus a number of corresponding NZP CSI-RS resources can be equal to two, where a kth NZP CSI-RS resource of a first of the two CSI-RS resource sets and a kth NZP CSI-RS resource of a second of the two CSI-RS resource set belong to the same CDM group. Two CSI-RSs corresponding to two NZP CSI-RS resources can be CDMed within a same CDM group if a UE is to receive the two CSI-RSs over a common set of RS, where the two CSI-RSs can be coded with different codes in a code domain.

Implementations also provide for near field events corresponding to identifying a near field UE, e.g., beams with gains that exceed thresholds, a best beam is different across different antenna subarrays, an identified root mean squared (RMS) delay, etc. In implementations, a UE is configured with a measurement or evaluation of a near field event, and the near field event may be configurable by a NE. The near field event may indicate that the UE is in a near field region.

In implementations, a near field event can correspond to where a beam quality value of at least one beam in multiple sets of beams exceeds a first threshold value. In at least one example, the near field event represents where a beam quality value of at least one beam in K set of beams in the multiple sets of beams exceeds the first threshold value. K may be equal to 1, 2, or equal to a number of sets of the multiple sets of beams. In other examples, K may be a fraction of the number of sets of the multiple the sets of beams, e.g., an integer number approximately one half of the number of sets of the multiple sets of beams. In another example, the first threshold value can be configurable by a NE. The beam quality value may correspond to an RSRP value or an SINR value.

In implementations, the near field event represents where a difference in beam quality values of a subset of the strongest beams in a given set of beams is smaller than a second threshold value. In one example, a near field event represents where RSRP values corresponding to a strongest beam in the first set of beams and a fourth strongest beam in the first set of beams is no larger than a 2 dB threshold value.

In implementations, the near field event represents where a first selected index of a first beam in the first set of beams is different from a second selected index of a second beam in the second set of beams, where a mapping of a beam with a corresponding index value is consistent or monotonic with an angle of departure of the beam in azimuth direction, zenith direction, or both. For instance, the first selected index of the first beam in the first set of beams is not QCLed with the second selected index of the second beam in the second set of beams.

In implementations, the near field event represents where a delay spread value corresponding to a difference in delay values of a first path and a second path of a channel is no larger than a third threshold value. In some examples, the first path and the second path correspond to an RMS delay spread value, where a first received power of the first path is \sqrt{2} fraction stronger than a second received power of the second path.

In implementations, the near field event represents multiple measurements or evaluations. For instance, a first measurement or evaluation can correspond to a beam quality value of at least one beam in the first set of beams exceeding a first threshold value. An ID value of the at least one beam, for example, is of value k. A second measurement or evaluation can correspond to a beam k in each of a remainder of the sets of beams in the multiple sets of beams having a beam quality value with a difference in value relative to the beam quality value of the at least one beam in the first set of beams exceeding a second threshold value. A near field event can be detected (e.g. occur) if both the first and second measurements/evaluations are confirmed. A total number of beams to be measured for measurements/evaluations can be K+M−1, where K is a number of beams in the first set of beams, and Mis a number of sets of beams.

In implementations where a near field event occurs, a UE can report an indication of the event occurrence. For example, the UE can report a flag (e.g., over UCI 1, other information over UCI 2) indicating occurrence of near field conditions, a corresponding beam quality, and/or beam quality of a subset of sets. The UE can report an index of a beam from each set of beams of the multiple sets of beams. An indication of an occurrence of a near field event may be in the form of a single bit corresponding to a flag bit. The UE may report a measure of a beam quality (e.g., RSRP value(s), SINR value(s)) corresponding to each reported beam for which an index is reported. The UE may report beam indices corresponding to a subset of the set of beams. A number of the subset of the set of beams may be based on a restriction on a maximum number of beams the UE is to monitor. The UE may combine multiple antenna subarrays which can enable a smaller number of updated antenna subarrays and a smaller number of updated sets of beams.

In implementations the UE may report the indication of the near field event occurrence in a first uplink resource, e.g., UCI bits over a PUCCH resource, SR, or piggybacked to an UL ACK/NACK signal. The first uplink resource can be followed by a second uplink resource (e.g., UCI bits over PUSCH), where a selection of the PUSCH resource from a pool of PUSCH resources can be based on information carried in the first uplink resource. The first uplink resource may include information associated with a number of beams reported over the second uplink resource, or a corresponding number of sets of beams associated with the reported beam indices. Reported information over the first uplink resource and the second uplink resource may correspond to two distinct CSI reports or two parts of a CSI report. In implementations of two parts of a CSI report, a first part of the CSI report can correspond to the first uplink resource is reported at least X slots or Y symbols before a second CSI report corresponding to the second uplink resource. Reported information corresponding to the second uplink resource can be a CSI report, and reported information corresponding to the second uplink resource may not be a CSI report.

In implementations, where a near field event is not detected (e.g., does not occur), a UE can report a NACK or take no action. The UE, for example, can report an indication of the event non-occurrence. The indication of the event non-occurrence may be in the form of a single bit corresponding to a flag bit. The UE may report a measure of one or more beam quality values (e.g., RSRP, SINR) corresponding to one or more beams from a set of beams. The set of beams may be set by a rule, e.g., a set with an ID value that is the smallest (or largest) among the multiple sets of beams. In at least some implementations, the UE may not transmit an event-related signal over a first uplink resource if the near field event does not occur.

In implementations, indications of blocked antenna arrays can be detected and/or reported. For example, a UE may report an index of a set of beams of the multiple sets of beams if beam quality values (e.g., RSRP values, SINR values) of beams in the set of beams are below a second threshold value. The UE may not report an ID of a beam in the set of beams, nor may the UE report an indication of beam quality values of a beam in the set of beams.

In implementations, and based on a beam reporting procedure, a UE in a near field region can be associated with multiple beams, with each beam corresponding to a respective antenna subarray. The UE in the near field region may receive a DMRS for PDSCH or PDCCH that is QCLed with a pool of CSI-RS resources, where each CSI-RS resource may correspond to an antenna subarray. The UE in the near field region may receive an SS/PBCH that is simultaneously QCLed with a pool of CSI-RS resources, where each CSI-RS resource may correspond to an antenna subarray. In scenarios where the UE in the near field region is QCLed with K>1 beams corresponding to K CSI-RS resources, an NE may serve K+1 UEs concurrently corresponding to the UE in the near field region served by K beams, in addition to K UEs in far field regions, where each UE is served by a respective beam of the K beams.

In implementations, multiple beam sets from multiple antenna subarrays can correspond to a same CSI-RS resource set configured with repetition. For instance, for a UE in a far field region, one set of beams may be used to obtain a best beam. However, in some examples, the UE can receive the multiple sets of beams, where beams of a first set of beams can be received over a different set of symbols or slots compared with beams of a second set of beams. In a first example, the multiple sets of beams can be received over multiple symbols over one or more slots in respective order of the sets of beams. In a second example, the multiple sets of beams can be received over a plurality of consecutive slots in respective order of the sets of beams. Alternatively, or additionally, the slots may not be consecutive but may be equally spaced in time, e.g., every four slots. In a third example, the multiple sets of beams can be received over a plurality of consecutive CCs or a plurality of consecutive RBGs in respective order of the sets of beams. Alternatively, or additionally, the CCs may not be consecutive but may be equally spaced in frequency, e.g., every two CCs.

In such implementations, UEs in the near field region may monitor the multiple sets of beams and report an index of a beam from each set of beams corresponding to each antenna subarray, whereas UEs in the far field region may apply different receive filters for the different sets of beams to identify a best receive beam for downlink reception, or a best reciprocal transmit beam for uplink transmission, or a combination thereof. In at least some examples, the multiple sets of beams correspond to a same NZP CSI-RS resource set configured with repetition. For instance, the beams corresponding to the CSI-RS resources of the NZP CSI-RS set correspond to a same set of beams transmitted from the NE over multiple transmission occasions. A first UE in the near field region can report a beam ID for each transmission occasion, and a second UE in the far field region can identify a best receive DL beam or a best transmit UL beam, where the second UE reports a beam ID for one transmission occasion of the multiple transmission occasions.

In implementations, near field UEs can be identified via an initial access procedure. For example, a UE can receive an SS/PBCH corresponding to a one or more SSBs, where each SSB corresponds to a beam. The UE measures a value of a beam quality corresponding to each received beam and the beam quality may correspond to an RSRP value or an SINR value. Upon receiving the SS/PBCH, the UE can transmit a PRACH preamble to the NE, where the PRACH preamble is associated with one beam from a set of beam indices corresponding to different SS/PBCH received at the UE.

In implementations, the UE is configured with an SIB message that includes indication information for a near field event. Examples of indication information for a near field event include a value of a beam quality of at least one beam exceeding a first threshold value, values of a beam quality of multiple beams exceeding a second threshold value, a difference in values of a beam quality of a subset of the one or more beams being no larger than a third threshold value, and combinations thereof. In at least one example, the SIB message is a SIB-1 message. In another example, a given threshold value is fixed or configured within the SIB message. The threshold value may be based on the carrier frequency, pathloss model as well as the aperture size, which may not be known to the UE.

In implementations, the UE can transmit an indication of near field event occurrence, such as over a PUSCH message. For example, a msg3 PUSCH corresponding to a response to a RAR sequence can include a field corresponding to a UE indication of whether the configured near field event has occurred. In an example, in case of near field event occurrence, a value of the field in the PUSCH message can be equal to one and if the near field event does not occur, the value of the field can be equal to zero. The field, for instance, can include a single bit. In another example, the field can include multiple bits, where different values of the multiple bits can correspond to occurrence of different combination of events, different configured threshold values of a same event, or a combination thereof, and where a value corresponding to none of the events occurring can be included.

In implementations, near field event configuration can correspond to a value of a beam quality of at least one beam exceeding the first threshold value, and where the first threshold value of the beam quality is indicated in the SIB message. If a near field event corresponding to the event configuration occurs, the UE can report a parameter including a first delta value (e.g., Δ₁) corresponding to a beam quality value minus the first threshold value, e.g.,

$${Δ}_{1} = {RSRP}_{current} - {RSRP}_{threshold , 1}$$

In implementations, the event configuration can correspond to values of a beam quality of a plurality of beams exceeding the second threshold value, and where at least one of a number of the plurality of beams and the second threshold value of the beam quality is indicated in the SIB message. If a near field event corresponding to the event configuration occurs, the UE can report at least one of a parameter including a second delta value (e.g., Δ₂) corresponding to a beam quality value minus the second threshold value, and a parameter including a number of beams whose beam quality value has exceeded the second threshold value.

In implementations, the event configuration corresponds to differences in values of a beam quality of a subset of the one or more beams not exceeding the third threshold value, e.g., a difference in beam quality values of the strongest two beams is smaller than the third threshold value. If a near field event corresponding to the event configuration occurs, the UE can report at least one of a parameter including a third delta value (e.g., Δ₃) corresponding to a difference in beam quality values of the two beams (b1 and b2) with the highest beam quality values, e.g.,

$${Δ}_{3} = {RSRP}_{b 1} - {RSRP}_{b 2}$$

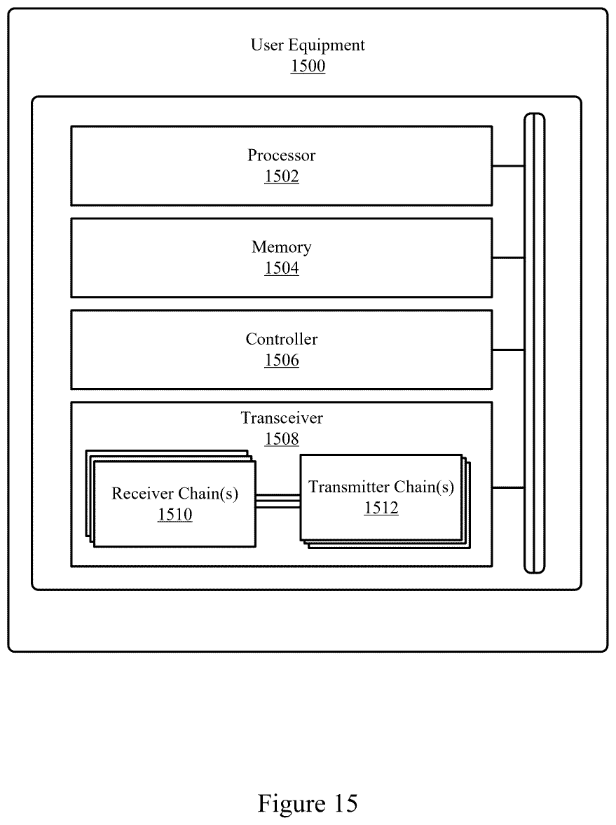

FIG. 15 illustrates an example of a UE 1500 in accordance with aspects of the present disclosure. The UE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the UE 1500 to perform various functions of the present disclosure.

The memory 1504 may include volatile or non-volatile memory. The memory 1504 may store computer-readable, computer-executable code including instructions when executed by the processor 1502 cause the UE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the UE 1500 to perform one or more of the functions described herein (e.g., executing, by the processor 1502, instructions stored in the memory 1504). For example, the processor 1502 may support wireless communication at the UE 1500 in accordance with examples as disclosed herein. The UE 1500 may be configured to or operable to support a means for receiving a set of beams; selecting a beam from the set of beams based at least in part on one or more beam quality values; transmitting a RACH preamble indicating an identifier of the selected beam; receiving a system information message including event information for a near field event; receiving a RAR message including an acknowledgement of the RACH preamble; and transmitting, based at least in part on the RAR message and the one or more beam quality values of the set of beams, an event indication of whether the near field event is detected.

Additionally, the UE 1500 may be configured to support any one or combination of where the near field event is configured to trigger a near-field operation mode, and the near-field operation mode corresponds to the UE being in a closer proximity to a NE compared with one or more other UEs that are not triggered with the near-field operation mode; further including: measuring the one or more beam quality values for each beam of the set of beams, where the selected beam is associated with a best beam quality within the set of beams based at least in part on the one or more beam quality values; each beam of the set of beams is associated with a SSB resource; the near field event corresponds to a beam quality value of the selected beam meeting a first threshold value, and where the event information includes the first threshold value; the beam quality value includes one or more of a RSRP value or a SINR value; the system information message includes a SIB-1 message.

Additionally, the UE 1500 may be configured to support any one or combination of where the near field event corresponds to a difference between a first beam quality value of the selected beam and a second beam quality value associated with a non-selected beam of the set of beams being smaller than a second threshold value; the non-selected beam corresponds to a beam associated with at least one of: a fourth best beam quality within the set of beams with a median beam quality within the set of beams; or a best beam quality of a subset of beams corresponding to a weakest beam quality within the set of beams; the first beam quality value and the second beam quality value include one or more of RSRP values or SINR values; the event indication of whether the near field event is detected is included in a field of a PUSCH; a presence of the field in the PUSCH is conditioned at least in part on the event information being included in the system information message; further including: receiving a contention resolution message subsequent to transmission of the event indication, where the contention resolution message includes at least one of an acknowledgement of the event indication or a cell radio network identifier; the system information message is received as part of an initial access procedure between the UE and a NE.

Additionally, or alternatively, the UE 1500 may support at least one memory (e.g., the memory 1504) and at least one processor (e.g., the processor 1502) coupled with the at least one memory and configured to cause the UE to receive a set of beams; select a beam from the set of beams based at least in part on one or more beam quality values; transmit a RACH preamble indicating an identifier of the selected beam; receive a system information message including event information for a near field event; receive a RAR message including an acknowledgement of the RACH preamble; and transmit, based at least in part on the RAR message and the one or more beam quality values of the set of beams, an event indication of whether the near field event is detected.

Additionally, the UE 1500 may be configured to support any one or combination of where the near field event is configured to trigger a near-field operation mode, and the near-field operation mode corresponds to the UE being in a closer proximity to a NE compared with one or more other UEs that are not triggered with the near-field operation mode; the at least one processor is configured to cause the UE to: measure the one or more beam quality values for each beam of the set of beams, where the selected beam is associated with a best beam quality within the set of beams based at least in part on the one or more beam quality values; each beam of the set of beams is associated with a SSB resource; the near field event corresponds to a beam quality value of the selected beam meeting a first threshold value, and where the event information includes the first threshold value; the beam quality value includes one or more of a RSRP value or a SINR value; the system information message includes a SIB-1 message; the near field event corresponds to a difference between a first beam quality value of the selected beam and a second beam quality value associated with a non-selected beam of the set of beams being smaller than a second threshold value.

Additionally, the UE 1500 may be configured to support any one or combination of where the non-selected beam corresponds to a beam associated with at least one of: a fourth best beam quality within the set of beams with a median beam quality within the set of beams; or a best beam quality of a subset of beams corresponding to a weakest beam quality within the set of beams; the first beam quality value and the second beam quality value include one or more of RSRP values or SINR values; the event indication of whether the near field event is detected is included in a field of a PUSCH; a presence of the field in the PUSCH is conditioned at least in part on the event information being included in the system information message; the at least one processor is configured to cause the UE to: receive a contention resolution message subsequent to transmission of the event indication, where the contention resolution message includes at least one of an acknowledgement of the event indication or a cell radio network identifier; the system information message is received as part of an initial access procedure between the UE and a NE.

The controller 1506 may manage input and output signals for the UE 1500. The controller 1506 may also manage peripherals not integrated into the UE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the UE 1500 may include at least one transceiver 1508. In some other implementations, the UE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

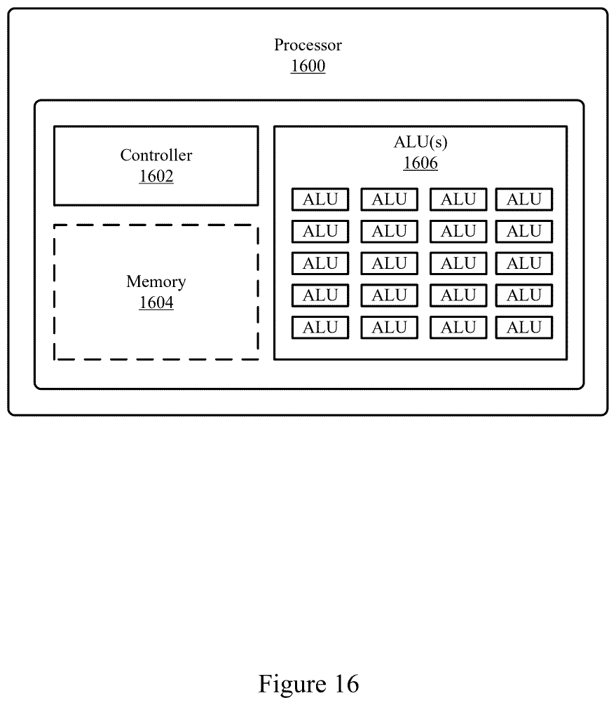

FIG. 16 illustrates an example of a processor 1600 in accordance with aspects of the present disclosure. The processor 1600 may be an example of a processor configured to perform various operations in accordance with examples as described herein. The processor 1600 may include a controller 1602 configured to perform various operations in accordance with examples as described herein. The processor 1600 may optionally include at least one memory 1604, which may be, for example, an L1/L2/L3 cache. Additionally, or alternatively, the processor 1600 may optionally include one or more arithmetic-logic units (ALUs) 1606. One or more of these components may be in electronic communication or otherwise coupled (e.g., operatively, communicatively, functionally, electronically, electrically) via one or more interfaces (e.g., buses).

The processor 1600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1602 may be configured to manage and coordinate various operations (e.g., signaling, receiving, obtaining, retrieving, transmitting, outputting, forwarding, storing, determining, identifying, accessing, writing, reading) of the processor 1600 to cause the processor 1600 to support various operations in accordance with examples as described herein. For example, the controller 1602 may operate as a control unit of the processor 1600, generating control signals that manage the operation of various components of the processor 1600. These control signals include enabling or disabling functional units, selecting data paths, initiating memory access, and coordinating timing of operations.

The controller 1602 may be configured to fetch (e.g., obtain, retrieve, receive) instructions from the memory 1604 and determine subsequent instruction(s) to be executed to cause the processor 1600 to support various operations in accordance with examples as described herein. The controller 1602 may be configured to track memory addresses of instructions associated with the memory 1604. The controller 1602 may be configured to decode instructions to determine the operation to be performed and the operands involved. For example, the controller 1602 may be configured to interpret the instruction and determine control signals to be output to other components of the processor 1600 to cause the processor 1600 to support various operations in accordance with examples as described herein. Additionally, or alternatively, the controller 1602 may be configured to manage flow of data within the processor 1600. The controller 1602 may be configured to control transfer of data between registers, ALUs 1606, and other functional units of the processor 1600.

The memory 1604 may include one or more caches (e.g., memory local to or included in the processor 1600 or other memory, such as RAM, ROM, DRAM, SDRAM, SRAM, MRAM, flash memory, etc. In some implementations, the memory 1604 may reside within or on a processor chipset (e.g., local to the processor 1600). In some other implementations, the memory 1604 may reside external to the processor chipset (e.g., remote to the processor 1600).

The memory 1604 may store computer-readable, computer-executable code including instructions that, when executed by the processor 1600, cause the processor 1600 to perform various functions described herein. The code may be stored in a non-transitory computer-readable medium such as system memory or another type of memory. The controller 1602 and/or the processor 1600 may be configured to execute computer-readable instructions stored in the memory 1604 to cause the processor 1600 to perform various functions. For example, the processor 1600 and/or the controller 1602 may be coupled with or to the memory 1604, the processor 1600, and the controller 1602, and may be configured to perform various functions described herein. In some examples, the processor 1600 may include multiple processors and the memory 1604 may include multiple memories. One or more of the multiple processors may be coupled with one or more of the multiple memories, which may, individually or collectively, be configured to perform various functions herein.

The one or more ALUs 1606 may be configured to support various operations in accordance with examples as described herein. In some implementations, the one or more ALUs 1606 may reside within or on a processor chipset (e.g., the processor 1600). In some other implementations, the one or more ALUs 1606 may reside external to the processor chipset (e.g., the processor 1600). One or more ALUs 1606 may perform one or more computations such as addition, subtraction, multiplication, and division on data. For example, one or more ALUs 1606 may receive input operands and an operation code, which determines an operation to be executed. One or more ALUs 1606 may be configured with a variety of logical and arithmetic circuits, including adders, subtractors, shifters, and logic gates, to process and manipulate the data according to the operation. Additionally, or alternatively, the one or more ALUs 1606 may support logical operations such as AND, OR, exclusive-OR (XOR), not-OR (NOR), and not-AND (NAND), enabling the one or more ALUs 1606 to handle conditional operations, comparisons, and bitwise operations.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to receive a set of beams; select a beam from the set of beams based at least in part on one or more beam quality values; transmit a RACH preamble indicating an identifier of the selected beam; receive a system information message including event information for a near field event; receive a RAR message including an acknowledgement of the RACH preamble; and transmit, based at least in part on the RAR message and the one or more beam quality values of the set of beams, an event indication of whether the near field event is detected.

Additionally, the processor 1600 may be configured to or operable to support any one or combination of where the near field event is configured to trigger a near-field operation mode, and the near-field operation mode corresponds to the UE being in a closer proximity to a NE compared with one or more other UEs that are not triggered with the near-field operation mode; the at least one processor is configured to cause the UE to: measure the one or more beam quality values for each beam of the set of beams, where the selected beam is associated with a best beam quality within the set of beams based at least in part on the one or more beam quality values; each beam of the set of beams is associated with a SSB resource; the near field event corresponds to a beam quality value of the selected beam meeting a first threshold value, and where the event information includes the first threshold value; the beam quality value includes one or more of a RSRP value or a SINR value; the system information message includes a SIB-1 message; the near field event corresponds to a difference between a first beam quality value of the selected beam and a second beam quality value associated with a non-selected beam of the set of beams being smaller than a second threshold value.

Additionally, the processor 1600 may be configured to or operable to support any one or combination of where the non-selected beam corresponds to a beam associated with at least one of: a fourth best beam quality within the set of beams with a median beam quality within the set of beams; or a best beam quality of a subset of beams corresponding to a weakest beam quality within the set of beams; the first beam quality value and the second beam quality value include one or more of RSRP values or SINR values; the event indication of whether the near field event is detected is included in a field of a PUSCH; a presence of the field in the PUSCH is conditioned at least in part on the event information being included in the system information message; the at least one processor is configured to cause the UE to: receive a contention resolution message subsequent to transmission of the event indication, where the contention resolution message includes at least one of an acknowledgement of the event indication or a cell radio network identifier; the system information message is received as part of an initial access procedure between the UE and a NE.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to transmit a set of beams; receive a RACH preamble indicating an identifier of a selected beam from the set of beams; transmit a system information message including event information for a near field event; transmit a RAR message including an acknowledgement of the RACH preamble; and receive, based at least in part on the RAR message and one or more beam quality values of the set of beams, an event indication of whether the near field event is detected.

Additionally, the processor 1600 may be configured to or operable to support any one or combination of where each beam of the set of beams includes a SSB resource; the near field event corresponds to a beam quality value of the selected beam meeting a first threshold value, and where the event information includes the first threshold value; the beam quality value includes one or more of a RSRP value or a SINR value; the system information message is transmitted as part of an initial access procedure between the NE and a UE.

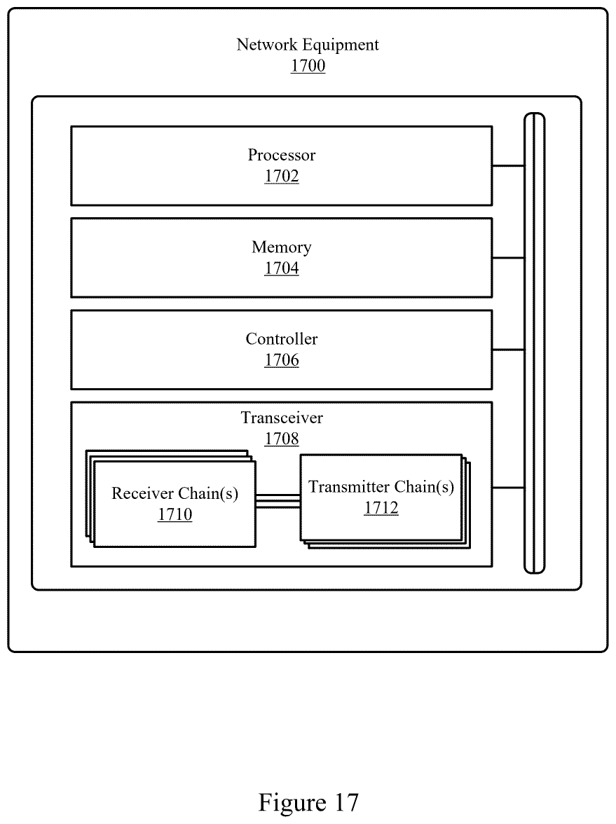

FIG. 17 illustrates an example of an NE 1700 in accordance with aspects of the present disclosure. The NE 1700 may include a processor 1702, a memory 1704, a controller 1706, and a transceiver 1708. The processor 1702, the memory 1704, the controller 1706, or the transceiver 1708, or various combinations thereof or various components thereof may be examples of means for performing various aspects of the present disclosure as described herein. These components may be coupled (e.g., operatively, communicatively, functionally, electronically, electrically) via one or more interfaces.

The processor 1702, the memory 1704, the controller 1706, or the transceiver 1708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1702 may include an intelligent hardware device (e.g., a general-purpose processor, a DSP, a CPU, an ASIC, an FPGA, or any combination thereof). In some implementations, the processor 1702 may be configured to operate the memory 1704. In some other implementations, the memory 1704 may be integrated into the processor 1702. The processor 1702 may be configured to execute computer-readable instructions stored in the memory 1704 to cause the NE 1700 to perform various functions of the present disclosure.

The memory 1704 may include volatile or non-volatile memory. The memory 1704 may store computer-readable, computer-executable code including instructions when executed by the processor 1702 cause the NE 1700 to perform various functions described herein. The code may be stored in a non-transitory computer-readable medium such as the memory 1704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1702 and the memory 1704 coupled with the processor 1702 may be configured to cause the NE 1700 to perform one or more of the functions described herein (e.g., executing, by the processor 1702, instructions stored in the memory 1704). For example, the processor 1702 may support wireless communication at the NE 1700 in accordance with examples as disclosed herein. The NE 1700 may be configured to or operable to support a means for transmitting a set of beams; receiving a RACH preamble indicating an identifier of a selected beam from the set of beams; transmitting a system information message including event information for a near field event; transmitting a RAR message including an acknowledgement of the RACH preamble; and receiving, based at least in part on the RAR message and one or more beam quality values of the set of beams, an event indication of whether the near field event is detected.

Additionally, the NE 1700 may be configured to or operable to support any one or combination of where the near field event is configured to trigger a near-field operation mode, and the near-field operation mode corresponds to a UE being in a closer proximity to the NE compared with one or more other UEs that are not triggered with the near-field operation mode; each beam of the set of beams is associated with a SSB resource; the near field event corresponds to a beam quality value of the selected beam meeting a first threshold value, and where the event information includes the first threshold value; the beam quality value includes one or more of a RSRP value or a SINR value; the system information message includes a SIB-1 message.

Additionally, the NE 1700 may be configured to or operable to support any one or combination of where the near field event corresponds to a difference between a first beam quality value of the selected beam and a second beam quality value associated with a non-selected beam of the set of beams being smaller than a second threshold value; the non-selected beam corresponds to a beam associated with at least one of: a fourth best beam quality within the set of beams with a median beam quality within the set of beams; or a best beam quality of a subset of beams corresponding to a weakest beam quality within the set of beams; the first beam quality value and the second beam quality value include one or more of RSRP values or SINR values; the event indication of whether the near field event is detected is included in a field of a PUSCH; a presence of the field in the PUSCH is conditioned at least in part on the event information being included in the system information message; further including: transmitting a contention resolution message subsequent to transmission of the event indication, where the contention resolution message includes at least one of an acknowledgement of the event indication or a cell radio network identifier; the system information message is received as part of an initial access procedure between the NE and a UE.

Additionally, or alternatively, the NE 1700 may support at least one memory (e.g., the memory 1704) and at least one processor (e.g., the processor 1702) coupled with the at least one memory and configured to cause the NE to transmit a set of beams; receive a RACH preamble indicating an identifier of a selected beam from the set of beams; transmit a system information message including event information for a near field event; transmit a RAR message including an acknowledgement of the RACH preamble; and receive, based at least in part on the RAR message and one or more beam quality values of the set of beams, an event indication of whether the near field event is detected.

Additionally, the NE 1700 may be configured to or operable to support any one or combination of where the near field event is configured to trigger a near-field operation mode, and the near-field operation mode corresponds to a UE being in a closer proximity to the NE compared with one or more other UEs that are not triggered with the near-field operation mode; each beam of the set of beams is associated with a SSB resource; the near field event corresponds to a beam quality value of the selected beam meeting a first threshold value, and where the event information includes the first threshold value; the beam quality value includes one or more of a RSRP value or a SINR value; the system information message includes a SIB-1 message.

Additionally, the NE 1700 may be configured to or operable to support any one or combination of where the near field event corresponds to a difference between a first beam quality value of the selected beam and a second beam quality value associated with a non-selected beam of the set of beams being smaller than a second threshold value; the non-selected beam corresponds to a beam associated with at least one of: a fourth best beam quality within the set of beams with a median beam quality within the set of beams; or a best beam quality of a subset of beams corresponding to a weakest beam quality within the set of beams; the first beam quality value and the second beam quality value include one or more of RSRP values or SINR values; the event indication of whether the near field event is detected is included in a field of a PUSCH; a presence of the field in the PUSCH is conditioned at least in part on the event information being included in the system information message; at least one processor is configured to cause the NE to transmit a contention resolution message subsequent to transmission of the event indication, where the contention resolution message includes at least one of an acknowledgement of the event indication or a cell radio network identifier; the system information message is received as part of an initial access procedure between the NE and a UE.

The controller 1706 may manage input and output signals for the NE 1700. The controller 1706 may also manage peripherals not integrated into the NE 1700. In some implementations, the controller 1706 may utilize an operating system such as iOS®, ANDROID®, WINDOWS®, or other operating systems. In some implementations, the controller 1706 may be implemented as part of the processor 1702.

In some implementations, the NE 1700 may include at least one transceiver 1708. In some other implementations, the NE 1700 may have more than one transceiver 1708. The transceiver 1708 may represent a wireless transceiver. The transceiver 1708 may include one or more receiver chains 1710, one or more transmitter chains 1712, or a combination thereof.

A receiver chain 1710 may be configured to receive signals (e.g., control information, data, packets) over a wireless medium. For example, the receiver chain 1710 may include one or more antennas to receive a signal over the air or wireless medium. The receiver chain 1710 may include at least one amplifier (e.g., a low-noise amplifier (LNA)) configured to amplify the received signal. The receiver chain 1710 may include at least one demodulator configured to demodulate the receive signal and obtain the transmitted data by reversing the modulation technique applied during transmission of the signal. The receiver chain 1710 may include at least one decoder for decoding the demodulated signal to receive the transmitted data.

A transmitter chain 1712 may be configured to generate and transmit signals (e.g., control information, data, packets). The transmitter chain 1712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1712 may also include at least one power amplifier configured to amplify the modulated signal to an appropriate power level suitable for transmission over the wireless medium. The transmitter chain 1712 may also include one or more antennas for transmitting the amplified signal into the air or wireless medium.

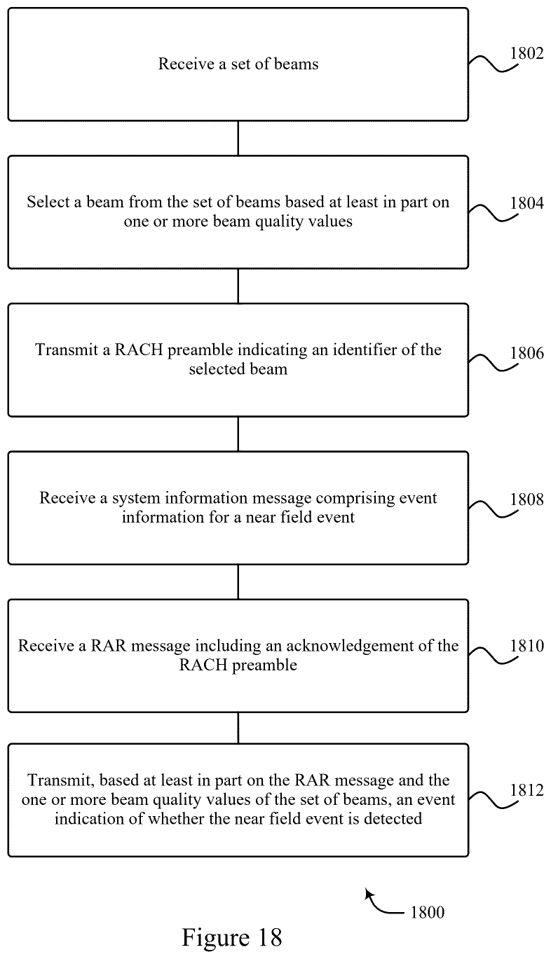

FIG. 18 illustrates a flowchart of a method 1800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1802, the method may include receiving a set of beams. The operations of 1802 may be performed in accordance with examples as described herein. In some implementations, aspects of the operations of 1802 may be performed by a UE as described with reference to FIG. 15.

At 1804, the method may include selecting a beam from the set of beams based at least in part on one or more beam quality values. The operations of 1804 may be performed in accordance with examples as described herein. In some implementations, aspects of the operations of 1804 may be performed by a UE as described with reference to FIG. 15.

At 1806, the method may include transmitting a RACH preamble indicating an identifier of the selected beam. The operations of 1806 may be performed in accordance with examples as described herein. In some implementations, aspects of the operations of 1806 may be performed a UE as described with reference to FIG. 15.

At 1808, the method may include receiving a system information message including event information for a near field event. The operations of 1808 may be performed in accordance with examples as described herein. In some implementations, aspects of the operations of 1808 may be performed a UE as described with reference to FIG. 15.

At 1810, the method may include receiving a RAR message including an acknowledgement of the RACH preamble. The operations of 1810 may be performed in accordance with examples as described herein. In some implementations, aspects of the operations of 1810 may be performed a UE as described with reference to FIG. 15.

At 1812, the method may include transmitting, based at least in part on the RAR message and the one or more beam quality values of the set of beams, an event indication of whether the near field event is detected. The operations of 1812 may be performed in accordance with examples as described herein. In some implementations, aspects of the operations of 1812 may be performed a UE as described with reference to FIG. 15.

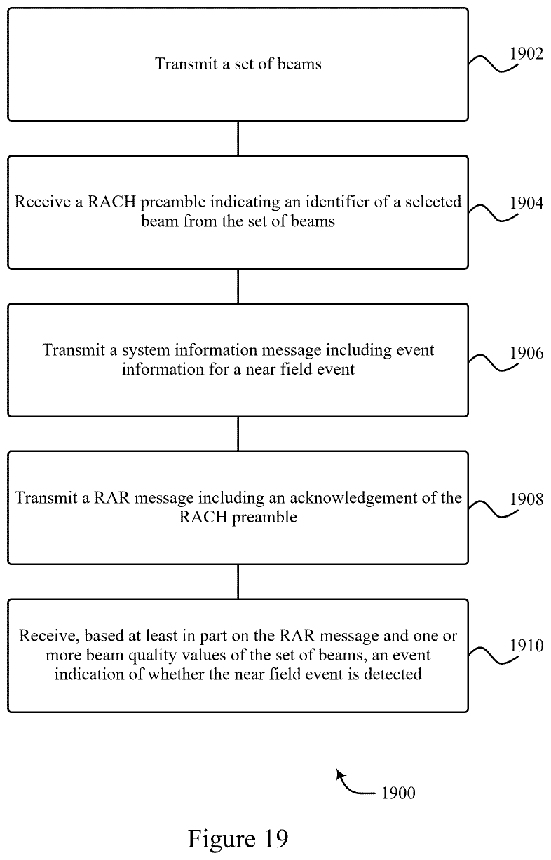

FIG. 19 illustrates a flowchart of a method 1900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1902, the method may include transmitting a set of beams. The operations of 1902 may be performed in accordance with examples as described herein. In some implementations, aspects of the operations of 1902 may be performed by an NE as described with reference to FIG. 17.

At 1904, the method may include receiving a RACH preamble indicating an identifier of a selected beam from the set of beams. The operations of 1904 may be performed in accordance with examples as described herein. In some implementations, aspects of the operations of 1904 may be performed by an NE as described with reference to FIG. 17.

At 1906, the method may include transmitting a system information message including event information for a near field event. The operations of 1906 may be performed in accordance with examples as described herein. In some implementations, aspects of the operations of 1906 may be performed an NE as described with reference to FIG. 17.

At 1908, the method may include transmitting a RAR message including an acknowledgement of the RACH preamble. The operations of 1908 may be performed in accordance with examples as described herein. In some implementations, aspects of the operations of 1908 may be performed an NE as described with reference to FIG. 17.

At 1910, the method may include receiving, based at least in part on the RAR message and one or more beam quality values of the set of beams, an event indication of whether the near field event is detected. The operations of 1910 may be performed in accordance with examples as described herein. In some implementations, aspects of the operations of 1910 may be performed an NE as described with reference to FIG. 17.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a set of beams;
select a beam from the set of beams based at least in part on one or more beam quality values;
transmit a random access channel (RACH) preamble indicating an identifier of the selected beam;
receive a system information message comprising event information for a near field event;
receive a random-access response (RAR) message including an acknowledgement of the RACH preamble; and
transmit, based at least in part on the RAR message and the one or more beam quality values of the set of beams, an event indication of whether the near field event is detected.

2. The UE of claim 1, wherein the near field event is configured to trigger a near-field operation mode, and the near-field operation mode corresponds to the UE being in a closer proximity to a network equipment (NE) compared with one or more other UEs that are not triggered with the near-field operation mode.

3. The UE of claim 1, wherein the at least one processor is configured to cause the UE to:
measure the one or more beam quality values for each beam of the set of beams, wherein the selected beam is associated with a best beam quality within the set of beams based at least in part on the one or more beam quality values.

4. The UE of claim 1, wherein each beam of the set of beams is associated with a synchronization signal block (SSB) resource.

5. The UE of claim 1, wherein the near field event corresponds to a beam quality value of the selected beam meeting a first threshold value, and wherein the event information includes the first threshold value.

6. The UE of claim 5, wherein the beam quality value comprises one or more of a reference signal received power (RSRP) value or a signal-to-interference-and-noise ratio (SINR) value.

7. The UE of claim 1, wherein the system information message comprises a system information block 1 (SIB-1) message.

8. The UE of claim 1, wherein the near field event corresponds to a difference between a first beam quality value of the selected beam and a second beam quality value associated with a non-selected beam of the set of beams being smaller than a second threshold value.

9. The UE of claim 8, wherein the non-selected beam corresponds to a beam associated with at least one of:
a fourth best beam quality within the set of beams with a median beam quality within the set of beams; or
a best beam quality of a subset of beams corresponding to a weakest beam quality within the set of beams.

10. The UE of claim 8, wherein the first beam quality value and the second beam quality value comprise one or more of reference signal received power (RSRP) values or signal-to-interference-and-noise ratio (SINR) values.

11. The UE of claim 1, wherein the event indication of whether the near field event is detected is included in a field of a physical uplink shared channel (PUSCH).

12. The UE of claim 11, wherein a presence of the field in the PUSCH is conditioned at least in part on the event information being included in the system information message.

13. The UE of claim 1, wherein the at least one processor is configured to cause the UE to:
receive a contention resolution message subsequent to transmission of the event indication, wherein the contention resolution message comprises at least one of an acknowledgement of the event indication or a cell radio network identifier.

14. The UE of claim 1, wherein the system information message is received as part of an initial access procedure between the UE and a network equipment (NE).

15. A processor for wireless communication, comprising:
at least one controller coupled with at least one memory and configured to cause the processor to:
receive a set of beams;
select a beam from the set of beams based at least in part on one or more beam quality values;
transmit a random access channel (RACH) preamble indicating an identifier of the selected beam;
receive a system information message comprising event information for a near field event;
receive a random-access response (RAR) message including an acknowledgement of the RACH preamble; and
transmit, based at least in part on the RAR message and the one or more beam quality values of the set of beams, an event indication of whether the near field event is detected.

16. A method performed by a user equipment (UE), the method comprising:
receiving a set of beams;
selecting a beam from the set of beams based at least in part on one or more beam quality values;
transmitting a random access channel (RACH) preamble indicating an identifier of the selected beam;
receiving a system information message comprising event information for a near field event;
receiving a random-access response (RAR) message including an acknowledgement of the RACH preamble; and
transmitting, based at least in part on the RAR message and the one or more beam quality values of the set of beams, an event indication of whether the near field event is detected.

17. A network equipment (NE) for wireless communication, comprising:
at least one memory; and
at least one processor coupled with the at least one memory and configured to cause the NE to:
transmit a set of beams;
receive a random access channel (RACH) preamble indicating an identifier of a selected beam from the set of beams;
transmit a system information message comprising event information for a near field event;
transmit a random-access response (RAR) message including an acknowledgement of the RACH preamble; and
receive, based at least in part on the RAR message and one or more beam quality values of the set of beams, an event indication of whether the near field event is detected.

18. The NE of claim 17, wherein each beam of the set of beams comprises a synchronization signal block (SSB) resource.

19. The NE of claim 17, wherein the near field event corresponds to a beam quality value of the selected beam meeting a first threshold value, and wherein the event information includes the first threshold value.

20. The NE of claim 19, wherein the beam quality value comprises one or more of a reference signal received power (RSRP) value or a signal-to-interference-and-noise ratio (SINR) value.
